(19) United States
(12) Patent Application Publication
(10) Pub. No.: US 2018/0225839 A1
(43) Pub. Date: Aug. 9, 2018

(54) INFORMATION ACQUISITION APPARATUS

(71) Applicants: Olympus Corporation, Tokyo (JP); Olympus Memory Works Corp., Tokyo (JP)

(72) Inventors: Hideaki YOSHIDA, Tokyo (JP); Hisayuki Harada, Tokyo (JP); Toshikazu HAYASHI, Tokyo (JP); Keiji OKADA, Tokyo (JP); Yuichi Tsuchimochi, Tokyo (JP); Osamu NONAKA, Sagamihara (JP)

(21) Appl. No.: 15/821,753

(22) Filed: Nov. 22, 2017

(30) Foreign Application Priority Data
Feb. 3, 2017 (JP) 2017-018482

(51) Int. Cl. G06T 7/60; G06K 9/62

(52) U.S. Cl. CPC G06T 7/60; H04N 5/23222; G06K 9/6267

(57) ABSTRACT

An information acquisition apparatus that acquires a photographed image of a member includes a processor. The processor includes: a target portion determination section that determines a portion that corresponds to a specified member as a target portion in the photographed image; and a measurement section that measures the target portion in the photographed image so as to acquire a shape of the specified member. The target portion determination section determines a corresponding target portion from among portions in the photographed image by using, as the specified member, a member that exists on a side close to a direction in which a camera for photographing exists.

### CROSS-REFERENCE TO RELATED APPLICATIONS

This application is based upon and claims the benefit of priority of the prior Japanese Patent Application No. 2017-18482, filed on Feb. 3, 2017, the entire contents of which are incorporated herein by reference.

### FIELD OF THE INVENTION

The present invention relates to an information acquisition apparatus that acquires a photographed construction image and the like.

### BACKGROUND OF THE INVENTION

### Description of the Related Art

Images photographed by a digital camera are overwhelmingly superior in immediacy to silver salt photographs, and therefore images photographed by digital cameras are widely used as evidence photographs in various business fields. As an example, at a construction site or an engineering work site, a system in which image data photographed by a digital camera is used as evidence photographs is widely used. Further, at a construction site, the shape of a member such as a pillar or a beam is measured by using photographed image data.

Various measurement technologies using a photographed image have been proposed. As an example, a three-dimensional camera that identifies a color distribution of an image by using a color sensor and that recognizes the height of an object to be measured has been proposed (Patent Document 1).

[Patent Document] Japanese Laid-Open Patent Publication No. 6-3122

### SUMMARY OF THE INVENTION

In order to achieve the object above, an information acquisition apparatus that acquires a photographed image of a member is provided. The information acquisition apparatus includes a processor that includes: a target portion determination section that determines a portion that corresponds to a specified member as a target portion in the photographed image; and a measurement section that measures the target portion in the photographed image so as to acquire a shape of the specified member. The target portion determination section determines the target portion that corresponds to the specified member from among portions in the photographed image by using, as the specified member, a member that exists on a side close to a direction in which a camera for photographing exists.

### BRIEF DESCRIPTION OF THE DRAWINGS

FIG. 1A illustrates an example of photographing of construction.

FIG. 1B illustrates an example of photographing of construction.

FIG. 2A illustrates the configuration of the entirety of an information acquisition system.

FIG. 2B is a block diagram illustrating details of a target portion determination section.

FIG. 3 is a hardware block diagram of an information acquisition apparatus.

FIG. 4A is flowchart 1 explaining target portion determination processing.

FIG. 4B is flowchart 2 explaining target portion determination processing.

FIG. 4C is flowchart 3 explaining target portion determination processing.

FIG. 5 illustrates an example of a setting screen on which a processing mode of an information acquisition apparatus is set.

FIG. 6 illustrates an example of highlighting.

FIG. 7A illustrates an example of a guide screen on which highlighting processing is performed.

FIG. 7B illustrates an example of a guide screen on which highlighting processing is performed.

FIG. 8A illustrates a principle of measuring the shape of a portion on the basis of a photographed image in a monocular system.

FIG. 8B illustrates a principle of measuring the shape of a portion on the basis of a photographed image in a binocular system.

FIG. 9 illustrates an example of configuration information based on a design drawing.

FIG. 10 illustrates a guide screen using second configuration information.

FIG. 11A illustrates a screen of result confirmation.

FIG. 11B illustrates a screen of result confirmation.

FIG. 12A is a subroutine of target portion determination 1.

FIG. 12B is a diagram explaining target portion determination 1.

FIG. 12C is a diagram explaining target portion determination 1.

FIG. 13A is a subroutine of target portion determination 2.

FIG. 13B illustrates a specific example of target portion determination 2.

FIG. 14A is a subroutine of target portion determination 3.

FIG. 14B illustrates a specific example of a member list.

FIG. 14C illustrates a specific example of design drawing information.

FIG. 15A is a subroutine of target portion determination 4.

FIG. 15B illustrates a specific example of target portion determination 4.

FIG. 16 is a flowchart of processing for displaying a photographing range guide.

FIG. 17 illustrates an example in which a photographing range guide is displayed in first configuration information.

FIG. 18A illustrates an example in which a photographing range guide is displayed in second configuration information.

FIG. 18B illustrates an example in which a photographing range guide is displayed in third configuration information.

FIG. 18C illustrates an example in which a panoramic image is displayed in a photographing range guide display.

FIG. 19A illustrates a principle of measuring a space between pillars in a facing state.

FIG. 19B illustrates a principle of measuring a space between pillars in an oblique direction.

FIG. 19C illustrates a principle of measuring a space between groundsills of a floor.

### DETAILED DESCRIPTION OF THE PREFERRED EMBODIMENTS

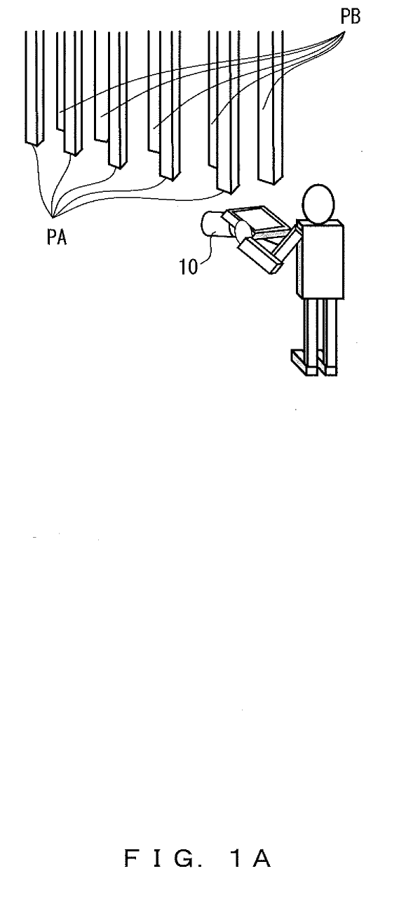

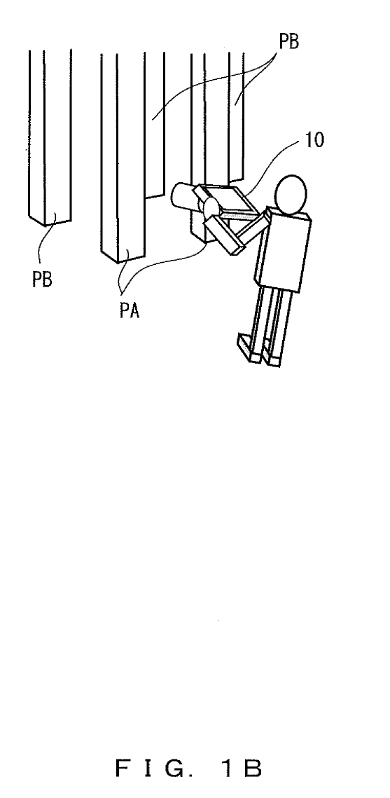

Embodiments of the present invention are described below with reference to the drawings. An information acquisition system 1 according to the present invention is described using an example of usage in photographing of construction. Photographing of construction is photographing that is performed in order to acquire evidence photographs and the like of the content of construction at a construction site. FIG. 1A and FIG. 1B illustrate states of photographing of construction.

FIG. 1A illustrates a state in which a photographer who is holding a photographing device 10 (hereinafter referred to as an information acquisition apparatus 10) is preparing photographing in a room in which a plurality of pillars have been constructed. Construction normally progresses from a depth side of FIG. 1. Pillars PA to be photographed this time are located on a front side, and photographed pillars PB are located on the depth side. Hereinafter, a construction portion to be photographed, such as a pillar or a beam, is also referred to as a part or a member. In a photographed image, a photographed member is also referred to as a photographed portion, or is simply referred to as a portion. In addition, a member that corresponds to the portion is also abbreviated as a member, unless this is not clear.

FIG. 1B illustrates a state in which a photographer is holding the information acquisition apparatus 10 so as to face pillars PA to be photographed, and is photographing the pillars PA. At the construction site, a portion that has been constructed is sequentially photographed. Therefore, when construction progresses, it is difficult to only photograph the pillars PA to be photographed this time, and pillars PB that have already been photographed and that are not targets to be photographed this time and other irrelevant portions are often included on a screen. Accordingly, a photographed image often includes both the pillars PA to be photographed and the photographed pillars PB.

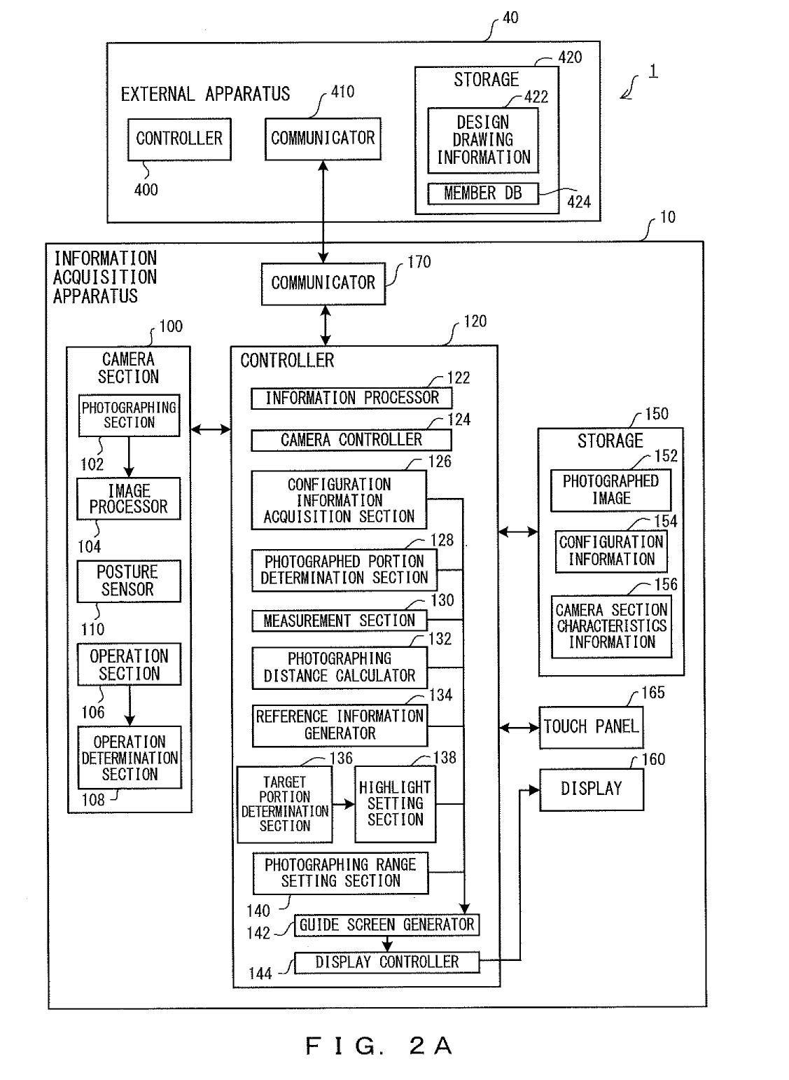

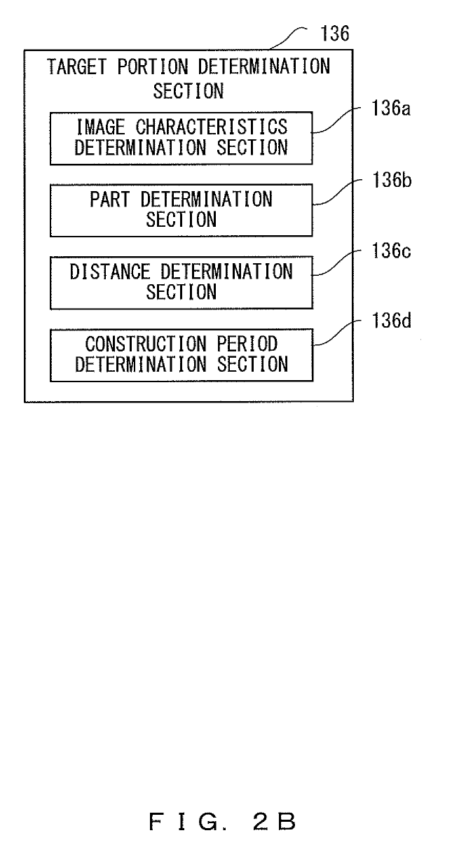

FIG. 2A illustrates the configuration of the entirety of the information acquisition system 1. The information acquisition system 1 is principally configured by the information acquisition apparatus 10 and an external apparatus 40. The information acquisition apparatus 10 is an apparatus that acquires a photographed image. The information acquisition apparatus 10 may be a “digital camera”, an “information processing device with a camera”, or a “system in which a camera and an information processing terminal (for example, a tablet-type information processing terminal) are combined by wire or wirelessly”. The external apparatus 40 is, for example, a server that is connected to the information acquisition apparatus 10 via a communication line and that stores a photographing result of the information acquisition apparatus 10.

The information acquisition apparatus 10 includes a camera section 100, a controller 120, a storage 150, a display 160, a touch panel 165, and a communicator 170. The camera section 100 is also simply referred to as a camera.

The camera section 100 includes a photographing section 102, an image processor 104, an operation section 106, an operation determination section 108, and a posture sensor 110. The photographing section 102 includes a lens 102a, an image sensor 102b, and the like that are not illustrated, and the photographing section 102 converts a subject image into an image signal. The image processor 104 converts the image signal output from the photographing section 102 into digital data, and performs various types of image processing.

The operation section 106 is an instruction member used to adjust a focal position or a focal length of the lens 102a in the photographing section 102. The operation determination section 108 determines an operation performed on the operation section 106. The posture sensor 110 is a sensor that detects the posture or orientation of the camera section 100. The posture sensor 110 includes, for example, an inclination sensor (an acceleration sensor) and an electronic compass.

The controller 120 totally controls the entirety of the information acquisition apparatus 10. The controller 120 includes an information processor 122, a camera controller 124, a configuration information acquisition section 126, a photographed portion determination section 128, a measurement section 130, a photographing distance calculator 132, a reference information generator 134, a target portion determination section 136, a highlight setting section 138, a photographing range setting section 140, a guide screen generator 142, a display controller 144, and the like.

The information processor 122 manages various types of determination processing and information input from the external apparatus 40 or the camera section 100. The camera controller 124 controls the camera section 100 according to an instruction input from the touch panel 165 so as to switch an operation mode of the camera section 100 or to perform photographing and the like.

The configuration information acquisition section 126 acquires configuration information from design drawing information 422 of the external apparatus 40 or an image photographed by the camera section 100. The configuration information is information indicating the configurations of a plurality of members to be photographed. The member to be photographed is a construction portion such as a pillar, a wall, or a beam. Two types of configuration information, first configuration information and second configuration information, are principally described below. The first configuration information is information indicating the configurations of a plurality of members based on a photographed image. The second configuration information is information indicating the configurations of a plurality of members based on a design drawing.

The configuration information acquisition section 126 acquires, as the first configuration information, an image that is photographed by the camera section 100 and in which all of a plurality of members are photographed. The configuration information acquisition section 126 also acquires the second configuration information from a design drawing of the external apparatus 40. Details of the configuration information will be described later.

The photographed portion determination section 128 determines a photographed member in a procedure of sequentially photographing a plurality of members. A large number of members that are similar in shape to each other are present at the construction site. Therefore, by specifying a photographed member in the process of photographing, useless duplicate photographing can be suppressed, and omission in photographing can also be prevented.

The measurement section 130 measures the shape of a portion on the basis of a photographed image, and outputs a measurement value. The shape of the portion is, for example, the width (the diameter) or height of a pillar in a case in which a member to be photographed is a pillar. When the member is a beam, the shape of the member is, for example, the thickness of the beam.

As illustrated in FIG. 1B, when a portion of a target member (hereinafter also referred to as a target portion) and the other portions are mixed on a screen, a target to be measured can fail to be set. Accordingly, the measurement section 130 performs measurement on the basis of a target portion determined by the target portion determination section 136. When a plurality of target portions are determined by the target portion determination section 136, the measurement section 130 performs measurement on the determined target portions.

The photographing distance calculator 132 calculates a distance from the camera section 100 to a member to be photographed (for example, a pillar). The photographing distance calculator 132 may calculate a photographing distance, for example, in the position of a focusing lens of the photographing section 102. In this case, a focus is detected in respective portions within a photographed image, and photographing distances that correspond to the respective portions are individually calculated such that the photographing distances to the respective portions can be obtained. In a case in which the photographing section 102 is of a binocular type, the photographing distance calculator 132 may calculate the photographing distance by performing phase difference ranging using right-hand and left-hand image sensors 102b. Phase difference ranging is a known scheme for detecting a deviation of an image position that corresponds to a point of interest on a subject in accordance with a degree of correlation between right-hand and left-hand subject images and for calculating a distance of the point of interest according to the principle of triangulation, and the distances of respective portions in a photographed image can be obtained in a single photographing.

The reference information generator 134 generates reference information that is a reference for photographing of construction by referring to a photographed image or a general standard reference photographing procedure (stored in an external database (DB) or the storage 150). As an example, the reference information generator 134 provides a photographing procedure that is generally used at the site as a “standard photographing guide”. The reference information generator 134 may provide a photographing procedure that has already been used in photographing of another floor in the same construction site (for example, a building) as a “similar photographing guide”.

The target portion determination section 136 determines a portion that corresponds to a specified member in a photographed image to be a target portion. Stated another way, the target portion determination section 136 determines a target portion on a screen on which a target portion and the other portions are mixed. In this embodiment, the target portion determination section 136 determines a portion (a member) constructed during the latest construction period to be a target portion. Namely, the target portion determination section 136 determines the latest constructed portion (member) on a screen to be a target portion.

Specifically, the target portion determination section 136 determines a surface layer portion of portions in a photographed image to be a target portion. The surface layer portion refers to a portion that corresponds to a member that exists on a closer side in a direction in which the camera section 100 exists. As described above, normally, construction progresses from a depth side at the construction site, and therefore a member that exists on a side closest to a photographer is a member constructed during the latest construction period. Correspondingly, a completed member that is located on a depth side is sequentially photographed. Thus, the surface layer portion can be regarded as a member constructed during the latest construction period.

A member constructed during the latest construction period may be directly specified according to construction period information of the member. A portion constructed during the latest construction period does not always include a single member, but may include a plurality of members. As an example, n pillars may be collectively constructed. In this case, a group of a plurality of portions corresponds to a target portion.

The target portion determination section 136 determines a target portion by using one or any combination of the following conditions. The target portion is a portion to be identified. As described later, the target portion is used as a target to be measured or a target to be highlighted.

The target portion determination section 136 determines the target portion according to a photographing distance that corresponds to a portion in a photographed image. In addition, the target portion determination section 136 may acquire the shape of a member to be photographed, and may determine the target portion by also using pattern matching. Further, the target portion determination section 136 may classify portions into groups according to the photographing distance, and may determine the target portion considering the groups of portions according to the photographing distance and the construction periods of members.

The target portion determination section 136 may determine a plurality of target portions on a single screen according to the characteristics of an image, the groups of portions according to the photographing distance, and the construction period. The number of photographed images can be reduced by collectively determining a plurality of target portions on a single screen and collectively performing measurement.

FIG. 2B is a block diagram illustrating details of the target portion determination section 136. The target portion determination section 136 includes an image characteristics determination section 136a, a part determination section 136b, a distance determination section 136c, and a construction period determination section 136d.

The image characteristics determination section 136a determines the characteristics (a shape, a size, or color) of each of the photographed portions. Specifically, the image characteristics determination section 136a determines the shape or color of a prism, a cylinder, a beam, or the like as characteristics. The part determination section 136b determines which type (a prism or a cylinder) of member (part) each of the portions determined by the image characteristics determination section 136a is in accordance with the shape or size of each of the portions.

The target portion determination section 136 compares the specifications of each of the members that is acquired from the design drawing information 422 or a member DB 424 with the type of the member determined by the part determination section 136b so as to determine whether the portion is a target portion. As an example, when a member that is a current target portion is a prism and it is determined that a portion on a screen is a cylinder, it is determined that the portion on the screen is not a target portion.

The distance determination section 136c classifies respective portions in a photographed image into groups having different photographing distances on the basis of photographing distances to the respective portions that have been calculated by the photographing distance calculator 132. The distance determination section 136c classifies respective photographed portions into groups, for example, at photographing distance intervals of 1 m.

The construction period determination section 136d acquires a construction period of each of the members from the design drawing information 422 or the member DB 424, and identifies the construction period of each of the members. The target portion determination section 136 determines a member constructed during the latest construction period according to the identified construction periods of the respective members, and determines a portion that corresponds to the member constructed during the latest construction period according to image characteristics and the like.

The highlight setting section 138 sets highlighting of the portion that the target portion determination section 136 has determined to be a target portion. A photographed image in which the target portion is highlighted is displayed on a live-view image, a rec-view image, or the guide screen described later. When the target portion determination section 136 determines a plurality of portions to be a target portion, the highlight setting section 138 sets highlighting of the determined plurality of portions.

The photographing range setting section 140 sets a photographing range according to a required accuracy of a measurement value of the shape of a member. When the photographing distance is increased, the photographing range is also increased, and a plurality of members can be collectively photographed. However, the accuracy of measurement is proportionally reduced due to a relationship with the resolving power of the image sensor 102b, or the like. Namely, when it is desired to measure the shape of a member with a high accuracy, photographing needs to be performed in a close position.

The photographing range setting section 140 calculates a photographing distance that satisfies a required accuracy of measurement according to the characteristics of the camera section 100. The characteristics of the camera section 100 include an MTF of the lens 102a, a distortion, the resolving power of the image sensor 102b, and the like. The photographing range setting section 140 sets a corresponding photographing range according to the calculated photographing distance and the characteristics of the camera section 100 (an angle of view of the lens 102a). The angle of view of the lens 102a is determined according to an F-value, a focal length, a focal position, and the like.

The guide screen generator 142 generates a guide screen that includes the acquired configuration information and in which situation information is added to a portion indicated by the configuration information. The situation information indicates a photographing situation based on the determination of the photographed portion determination section 128, and the photographing situation is, for example, the development or progress of photographing. The guide screen is displayed as needed during photographing.

The guide screen generator 142 causes the guide screen to include a photographed image (a live-view image or a rec-view image) of the portion and photographing condition information in addition to the configuration information with the situation information added. The photographing condition information indicates the measured shape (size) of a portion, a photographing distance, the required accuracy of the shape of the portion, a recommended photographing distance that assures the required accuracy, and the like. The guide screen is also referred to as a photographing guide screen.

In addition, the guide screen generator 142 generates a guide screen obtained by adding the photographing range set by the photographing range setting section 140 to the configuration information. The set photographing range is indicated as a photographing range guide on a screen indicating the configuration information. Details of the photographing range guide are described in Embodiment 2.

The guide screen is used to report, to a photographer, information that enables efficient, accurate, and appropriate photographing based on information relating to the performance and functions of the camera section 100 according to the environment at the time of photographing measurement and a target object for photographing measurement. As an example, the guide screen generator 142 may display and report reference information generated by the reference information generator 134 in addition to these pieces of information, the accuracy of measurement, the target object, the environment, and the like. By doing this, a guide screen is displayed that enables a portion to be accurately measured and also efficiently enables a large number of measurements at a single time. The guide screen generator 142 generates the guide screen according to the performance of the camera section 100, the accuracy of the measurement section 130, the actual arrangement and sizes of respective portions, and the like. The guide screen may be generated considering a position, a space, or the like in which a photographer can perform photographing.

The display controller 144 causes the display 160 to display a “photographed image”, a “setting screen for setting a mode and the like”, a “guide screen”, or the like. The storage 150 is a non-volatile storage. A photographed image 152, configuration information 154, camera section characteristics information 156, and the like are stored in the storage 150. The photographed image 152 is image data that is photographed and recorded by the camera section 100. The photographed image 152 may include information relating to a target portion determined by the target portion determination section 136. An image highlighted by the highlight setting section 138 may be used as the photographed image 152. The configuration information 154 is information acquired by the configuration information acquisition section 126. The stored configuration information 154 may one of the first configuration information and the second configuration information or both the first configuration information and the second configuration information.

The camera section characteristics information 156 is characteristics information relating to, in particular, the lens 102a or the image sensor 102b of the camera section 100. The characteristics information of the lens 102a indicates brightness, resolution, distortion, and the like in addition to the specifications. The characteristics information of the image sensor 102b indicates a pixel size, the number of pixels, a pixel pitch, and the like.

The display 160 is, for example, an LCD, and displays a photographed image, a guide screen, and the like. The touch panel 165 is an operation section that is configured integrally with the display 160, and various instructions from a photographer are input to the touch panel 165. The communicator 170 is an interface that performs various types of information communication with the external apparatus 40. The communicator 170 performs communication with the external apparatus 40 via a network (not illustrated). The communicator 170 can identify a connection destination, a request from the connection destination, and the like according to reception, connection setting, and the like, and this enables the controller 120 to determine the required specifications of various types of measurement, and the like. In this communication, the external apparatus 40 may transmit the required specifications.

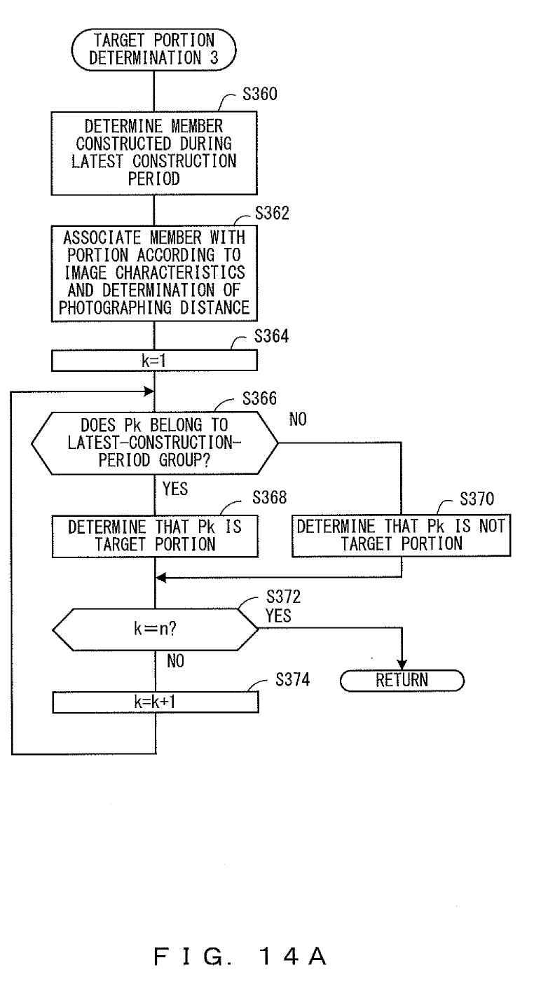

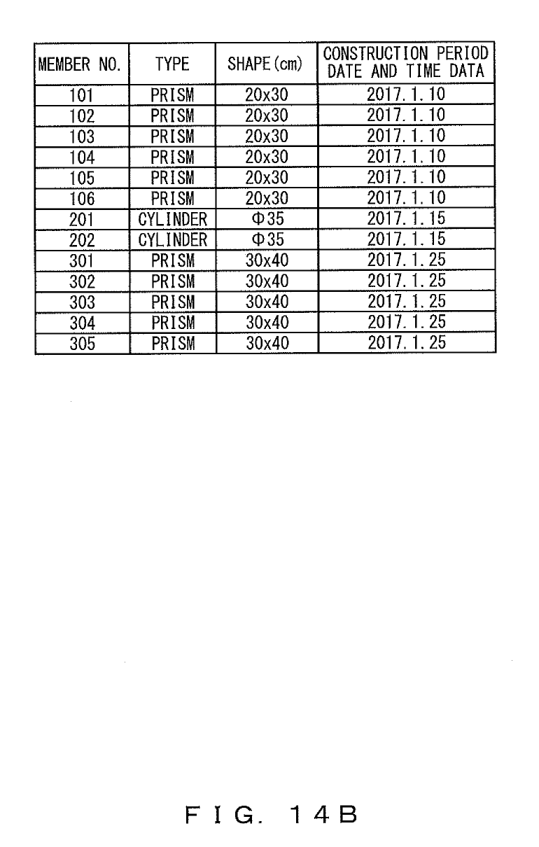

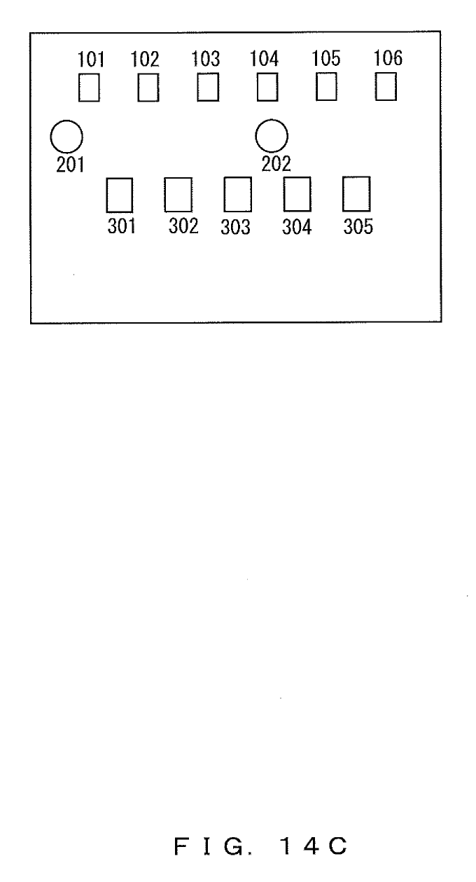

The external apparatus 40 includes a controller 400, a communicator 410, and a storage 420. The external apparatus 40 is a server that manages photographing of construction. The controller 400 totally controls the external apparatus 40. The communicator 410 is an interface that performs information communication, for example, with the information acquisition apparatus 10. The storage 420 includes the design drawing information 422 and the member database (DB) 424. The member DB will be described later with reference to FIG. 14B. A photographing result (an image of a photographed portion, the report described later, and the like) of photographing in the information acquisition apparatus 10 is stored in the storage 420.

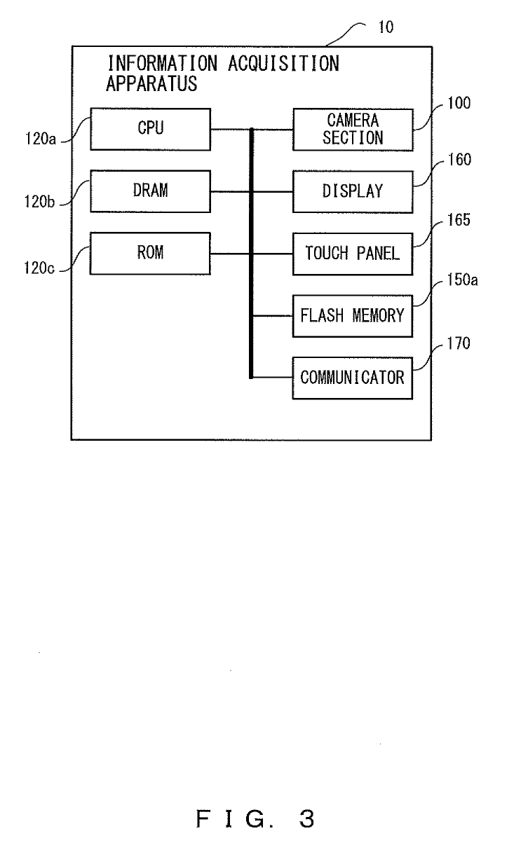

FIG. 3 is a hardware block diagram of the information acquisition apparatus 10. The information acquisition apparatus 10 includes a central processing unit (CPU) 120a, a dynamic random access memory (DRAM) 120b, a read-only memory (ROM) 120c, a flash memory 150a, a display 160, a touch panel 165, and a communicator 170.

The CPU 120a reads and executes a control program stored in the ROM 120c, and controls the information acquisition apparatus 10 by performing software processing. The DRAM 120b provides a working area in which the control program and various types of data are transitorily stored. The ROM 120c stores the control program in a non-volatile manner. The controller 120 is implemented by the CPU 120a, the DRAM 120b, and the ROM 120c. The controller 120 is also referred to as a processor.

The flash memory 150a stores various data tables and a photographed image. The storage 150 is configured by the flash memory 150a. The display 160, the touch panel 165, and the communicator 170 have been described above, and the description thereof is omitted.

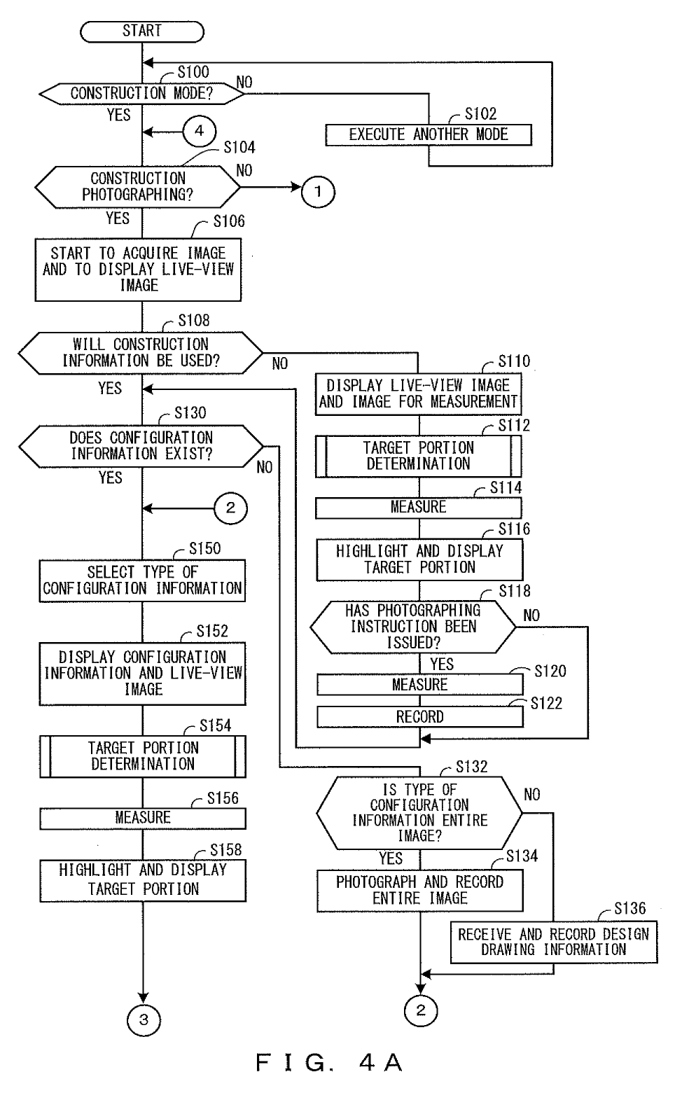

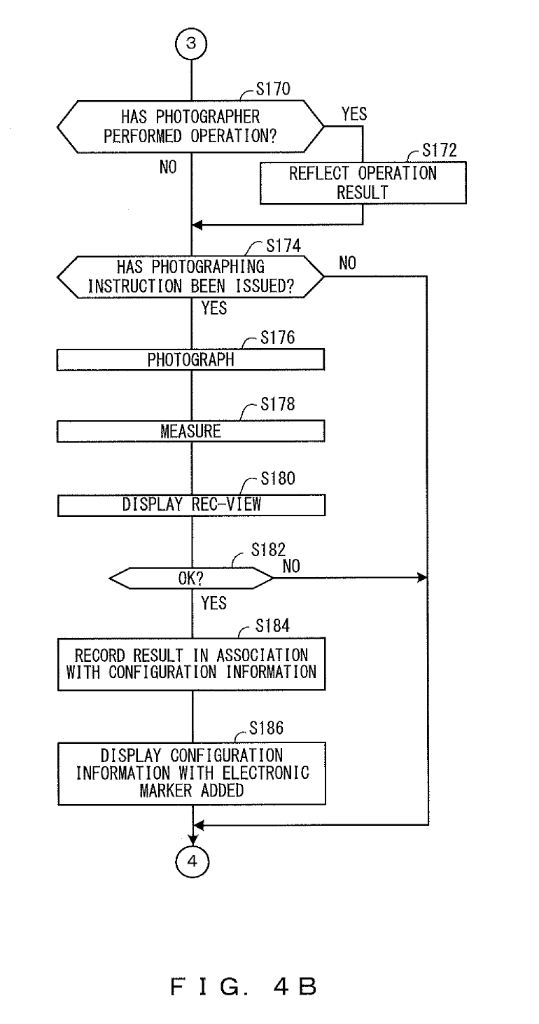

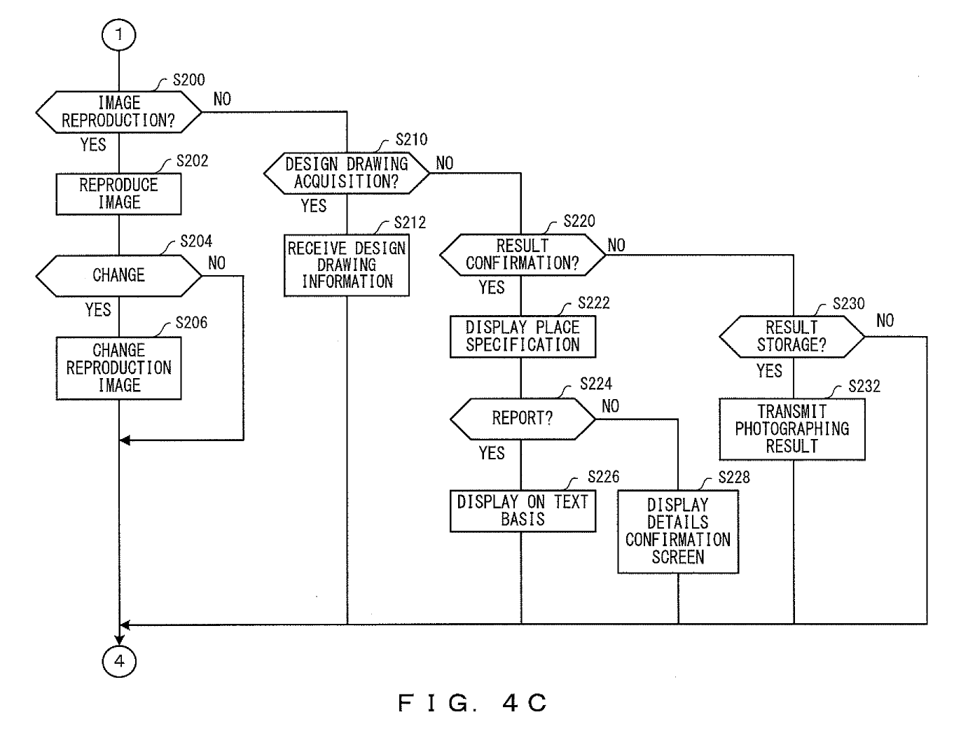

Image acquisition processing performed by the information acquisition apparatus 10 is described below. The image acquisition processing includes target portion determination processing. FIG. 4A to FIG. 4C are respectively flowchart 1 to flowchart 3 that explain the target portion determination processing. The image acquisition processing is principally performed by the controller 120 of the information acquisition apparatus 10.

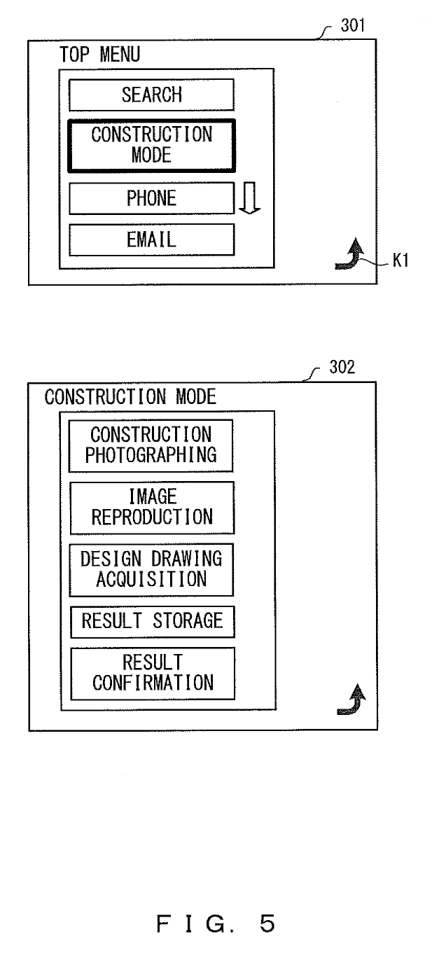

First, the controller 120 determines whether the information acquisition apparatus 10 has selected a construction mode (step S100). FIG. 5 illustrates a screen displayed on the display 160, and illustrates a setting screen on which a processing mode of the information acquisition apparatus 10 is set.

A setting screen 301 of FIG. 5 is a mode setting screen, and indicates a state in which a construction mode, which is the second mode from the top, has been selected. K1 is the button “return”. A setting screen 302 of FIG. 5 is a screen on which specific processes included in the construction mode are displayed after the construction mode is selected. The construction mode includes the sub-modes “construction photographing”, “image reproduction”, “design drawing acquisition”, “result storage”, and “result confirmation”.

“Construction photographing” is a process for photographing a construction portion. “Image reproduction” is a process for reproducing a photographed image.

“Design drawing acquisition” is a process for acquiring the design drawing information 422 as the second configuration information in the configuration information 154 from the storage 420 of the external apparatus 40. “Result confirmation” is a process in which a photographer or a manager confirms the content of photographing on the basis of images of respective portions photographed by the information acquisition apparatus 10. The photographer or the manager confirms, on the confirmation screen described later, that there is no omission in photographing and that a photographed portion has no defects. “Result storage” is a process for transmitting, to the external apparatus 40, a result (a photographed image, information relating to the shape of a portion, or information relating to a determined target portion) of photographing in the information acquisition apparatus 10, and for storing the result in the external apparatus 40.

When the controller 120 determines that the information acquisition apparatus 10 has not selected the construction mode (NO in step S100), the controller 120 executes another mode that has been selected (step S102).

When the controller 120 determines that the information acquisition apparatus 10 has selected the construction mode (YES in step S100), the controller 120 determines whether “construction photographing” has been selected on the setting screen 302 of FIG. 5 indicating the construction mode (step S104).

When the controller 120 determines that “construction photographing” has been selected (YES in step S104), the controller 120 starts to acquire an image by using the camera section 100 and to display a live view using the acquired image (Step S106).

The controller 120 determines whether the configuration information 154 will be used in accordance with an instruction from a photographer, or the like (step S108). When the controller 120 determines that the configuration information 154 will not be used (NO in step S108), the controller 120 displays a live-view image and an image for measurement (step S110).

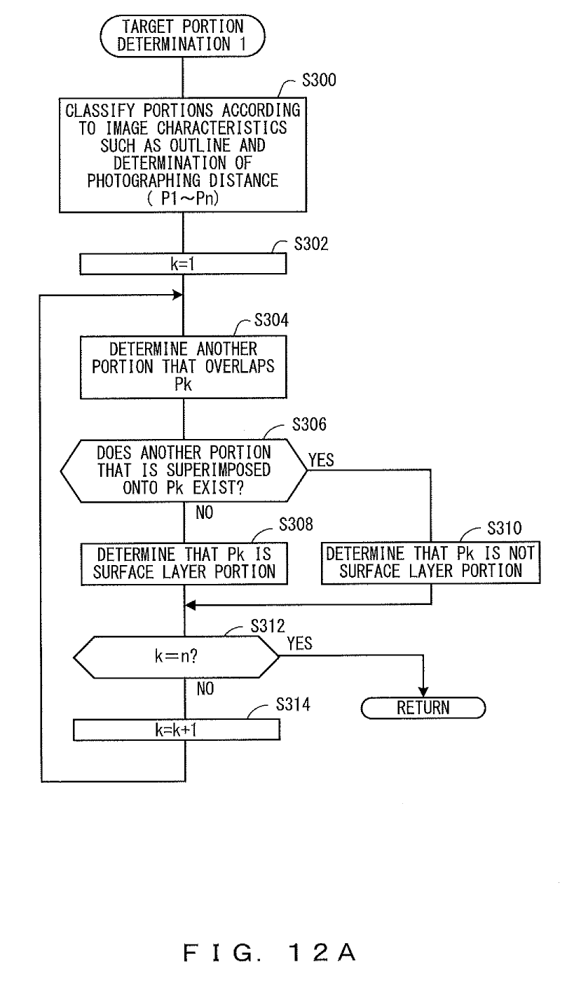

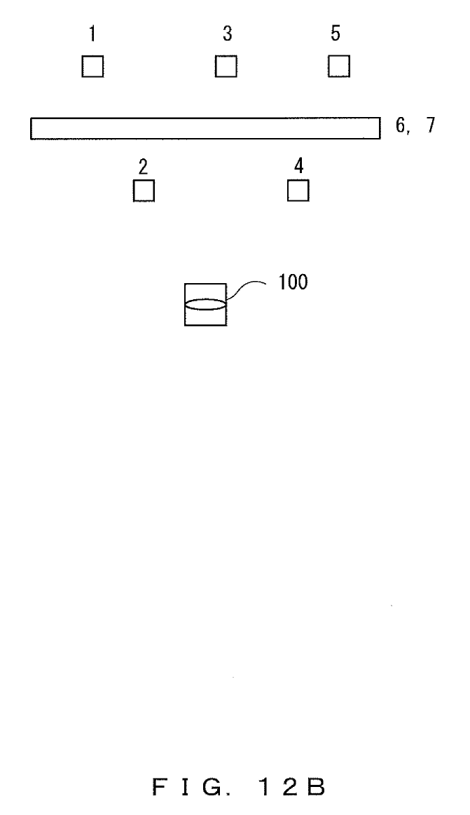

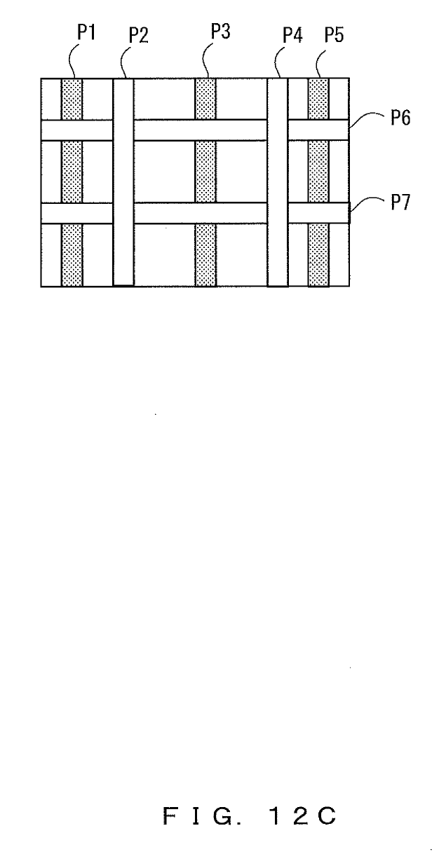

The target portion determination section 136 determines a target portion on the basis of the live-view image (step S112). Details of the determination of the target portion will be described later with reference to FIG. 12A to FIG. 15B. The measurement section 130 measures the shape of the determined target portion (step S114). The highlight setting section 138 sets the target portion so as to be highlighted. The controller 120 displays a photographed image on which highlighting processing has been performed and a measurement result (step S116).

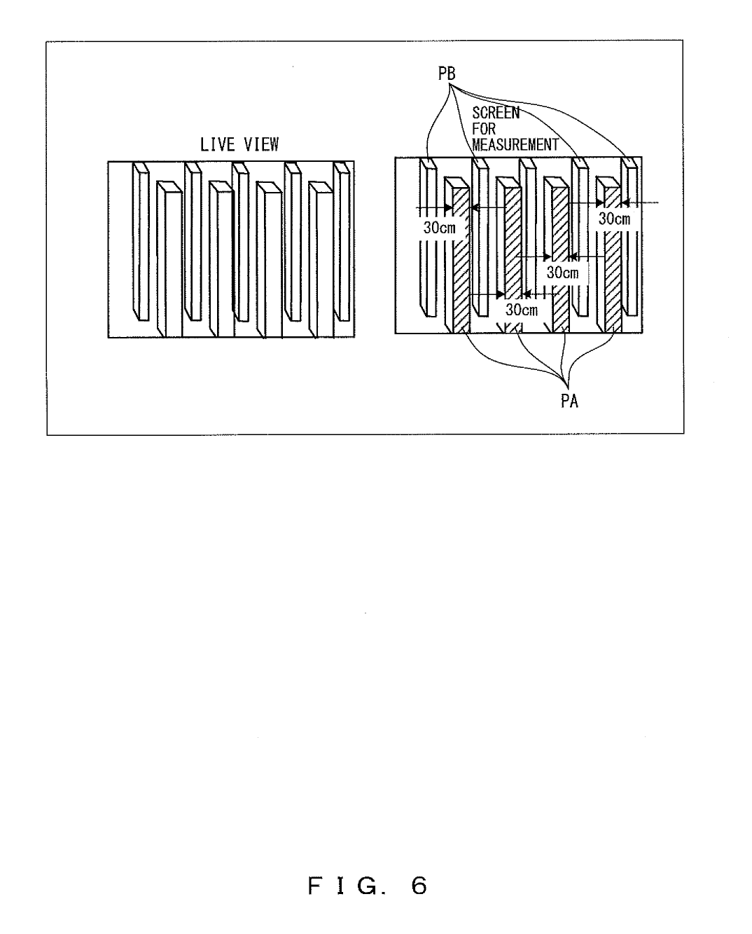

FIG. 6 illustrates an example of a display of a live-view image and an image for measurement. A normal live-view image is indicated on a left-hand side of a screen, and a screen for measurement is indicated on a right-hand side of the screen. The screen for measurement displays a live-view image on which highlighting processing has been performed and to which a measured shape (size) is added. Four pillars PA that are closer to the camera section 100 are highlighted relative to five pillars PB located on the depth side. All of the measurement results of the four pillars PA on a front side are displayed to be 30 cm.

The controller 120 determines whether a photographing instruction has been issued (step S118). When the controller 120 determines that a photographing instruction has been issued (YES in step S118), the controller 120 performs photographing (step S118). The measurement section 130 measures the width of a pillar that is the target portion on the basis of a photographed image (step S120). The controller 120 records the photographed image and a measurement result in the storage 150 (step S122). After step S122 or when the controller 120 determines that a photographing instruction has not been issued (NO in step S118), the processing moves on to step S130.

When the controller 120 determines that the configuration information 154 will be used (YES in step S108), the controller 120 determines whether the configuration information 154 exists (step S130). Hereinafter, in a case in which the types of the configuration information 154 are distinguished from each other, the configuration information 154 is referred to as first configuration information 154a or second configuration information 154b.

The controller 120 determines whether the first configuration information 154a or the second configuration information 154b is stored in the storage 150. When the controller 120 determines that no configuration information is stored (NO in step S130), the controller 120 determines from an instruction from a photograph whether the type of configuration information to be acquired is the entire image (the first configuration information 154a) (step S132). When the controller 120 determines that the entire image has been specified as the type of configuration information to be acquired (YES in step S132), the controller 120 issues an instruction to photograph the entire image to the photographer. The entire image is photographed by the photographer. The controller 120 records the entire image photographed by the photographer as the first configuration information 154a in the storage 150 (step S134).

When the controller 120 determines that the type of the configuration information 154 is not the entire image, namely, that a specified type of the configuration information 154 is a design drawing (NO in step S132), the controller 120 acquires the design drawing information 422 from the storage 420 in the external apparatus 40 via the communicator 170, and records the design drawing information 422 as the second configuration information 154b in the storage 150 (step S136). After step S134 or step S136, the processing of the controller 120 moves on to S150.

When the controller 120 determines that the configuration information 154 exists (YES in step S130), the controller 120 causes the photographer to select the type of configuration information 154 to be used (step S150). The guide screen generator 142 generates a guide screen from an image obtained by combining the selected configuration information 154 and a live-view image. The controller 120 displays the guide screen including the configuration information 154 and the live-view image on the display 160 (step S152). An image of the configuration information and the live-view image are divided and displayed.

The target portion determination section 136 determines a target portion on the basis of the configuration information or the live-view image (step S154). The determination of the target portion will be described with reference to FIG. 12A to FIG. 15B, as described above. The measurement section 130 measures the shape of the determined target portion (step S156). The highlight setting section 138 sets the target portion so as to be highlighted. The controller 120 displays a photographed image on which highlighting processing has been performed and a measurement result (step S158).

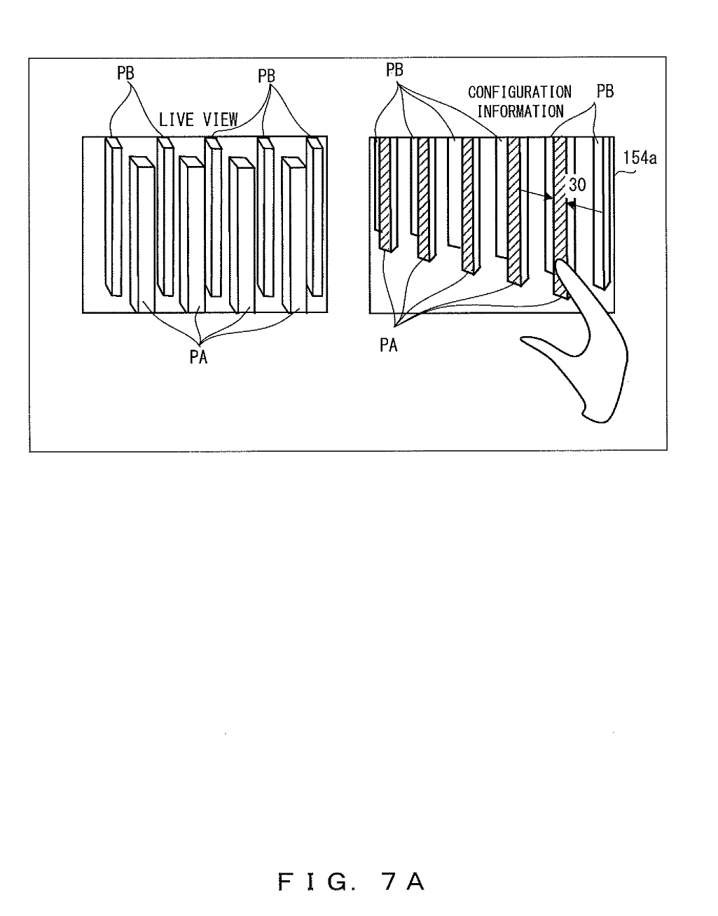

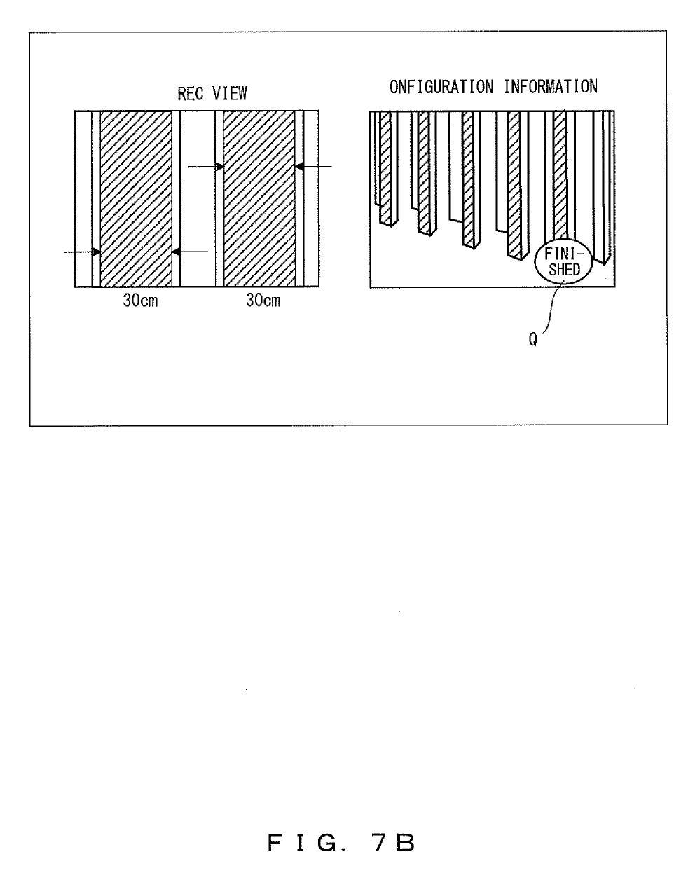

FIG. 7A and FIG. 7B illustrate examples in which highlighting processing has been performed on an image of a guide screen. FIG. 7A illustrates a screen in a state in which a photographer is considering a layout. In FIG. 7A, a live-view image is illustrated on a left-hand side of the screen, and configuration information is illustrated on a right-hand side of the screen. The entire image of the interior of a room that has been photographed in advance is displayed as the configuration information. In the configuration information, pillars PA that exist closer to the camera section 100 are determined to be a portion to be photographed, and the pillars PA are highlighted relative to pillars PB, which are located on a depth side. FIG. 7A illustrates an example in which highlighting processing has been performed on an image of the configuration information, but highlighting processing may be performed on the live-view image.

When only either of the first configuration information 154a and the second configuration information 154b is stored in the storage 150, step S150 is omitted, and configuration information 154 stored in the storage 150 is displayed in step S152.

The measurement section 130 measures the target portion on the basis of the live-view image (step S156). The guide screen generator 142 may add a measurement result (the shape of the portion) to the guide screen. The controller 120 displays configuration information (the entire image) on which highlighting processing has been performed and to which a measurement result has been added (step S158; see FIG. 7A). FIG. 7B illustrates an example of a rec-view image, and details will be described later.

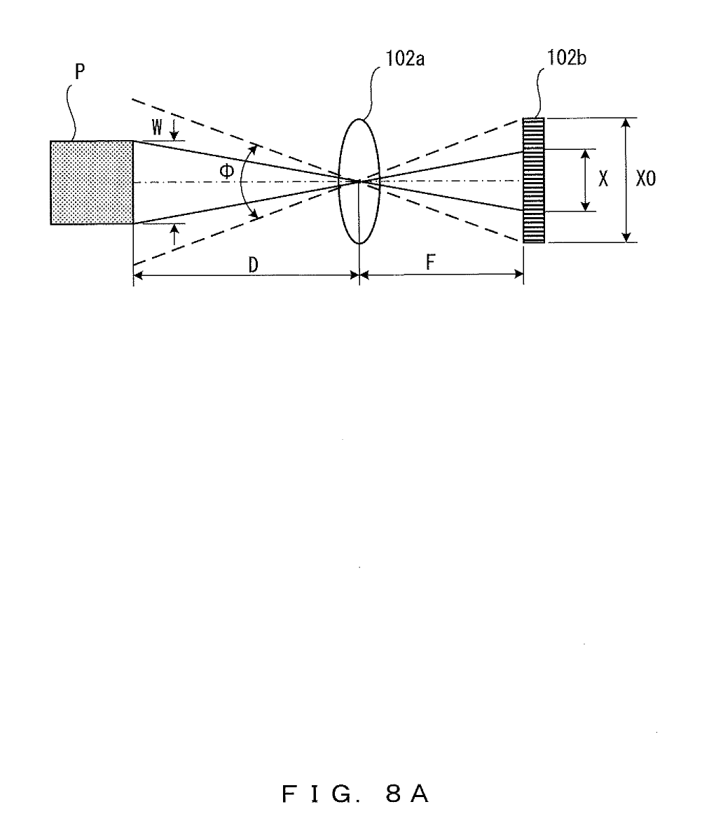

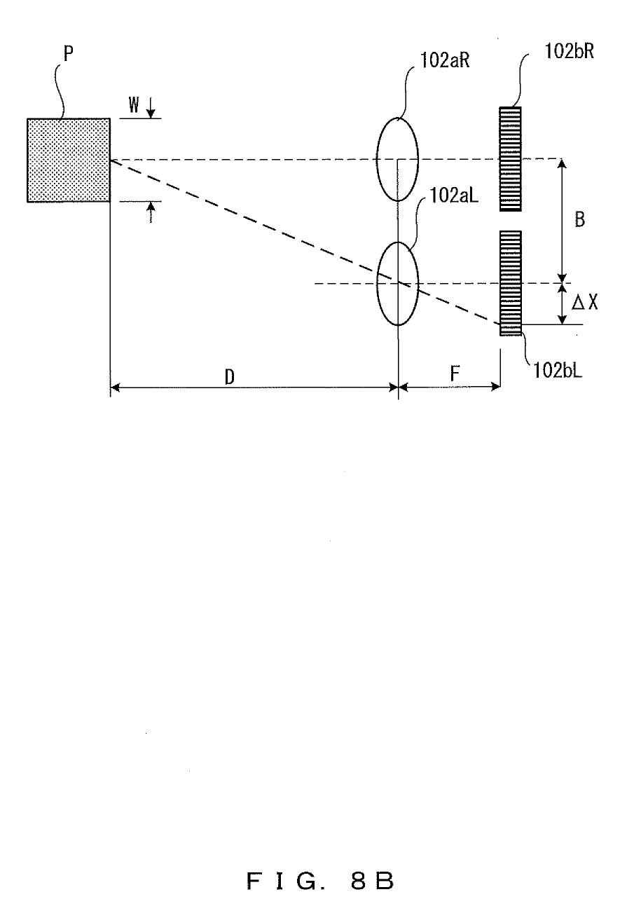

FIG. 8A and FIG. 8B schematically illustrate a principle of measuring the shape of a portion (in this example, the width of a pillar P) on the basis of a photographed image. Both of the drawings illustrate a state in which the camera section 100 in the process of photographing is viewed from the above. FIG. 8A illustrates an example in which the photographing section 102 is of a monocular type, and FIG. 8B illustrates an example in which the photographing section 102 is of a binocular type.

In FIG. 8A, assume that W is the width of a portion (a pillar P), X0 is the width of the image sensor 102b, φ is an angle of view of the lens 102a, F is a focal length of the lens 102a, and D is a photographing distance. The width X0, the angle of view φ, and the focal length F are included in the camera section characteristics information 156. The photographing distance D is calculated, for example, from a focal position detected according to contrast AF by the photographing distance calculator 132. When the photographing section 102 is of a monocular type, the width W of the pillar P is calculated according to the following formulae.

W=D×X/F (1)

φ=2×arctan(X0/(2×F)) (2)

Strictly speaking, a portion indicated by F (focal length) in formulae (1) and (2) should be an image plane distance obtained by adding an image plane movement due to focusing (in the case of a fixed focus system, a fixed image plane distance) to the focal length F, but F is used for simplicity of description. Hereinafter, similar simplification is used without any special notice.

X, which is the width of a portion (the pillar P) in a subject image on an image sensor, can be obtained according to any of various known methods. As an example, so-called “background separation” using an analysis of characteristics such as the luminance, contrast, or color of an image is applied, and the number of pixels of an extracted primary subject portion (a portion of the pillar P) is obtained as X.

In FIG. 8B, assume that a lens 102aR and an image sensor 102bR are a lens and an image sensor on a right-hand side when viewed from a photographer. Also assume that a lens 102aL and an image sensor 102bL are a lens and an image sensor on a left-hand side when viewed from the photographer. Assume that B is a parallax between right-hand and left hand image sensors 102b, and that ΔX is a relative image position. Further assume that the center of the pillar P is arranged on an optical axis of the lens 102aR. When the photographing section 102 is of a binocular type, the photographing distance D is calculated using the parallax B and the relative image position ΔX by the photographing distance calculator 132.

D=F×B/ΔX (3)

W is calculated using D, which is calculated according to formula (3), according to formula (1).

Proceed now to the description of FIG. 4B. The controller 120 determines whether an operation has been performed by a photographer (step S170). The operation performed by the photographer is, for example, a zoom operation of the operation section 106. When the controller 120 determines that an operation has been performed by the photographer (YES in step S170), the camera controller 124 performs control that reflects an operation result (step S172).

When the controller 120 determines that an operation has not been performed by the photographer (NO in step S170), the controller 120 waits for a photographing instruction (step S174). When the controller 120 determines that the photographing instruction has been issued (YES in step S174), the controller 120 performs photographing (step S176).

The measurement section 130 measures the shape of a target portion on the basis of a rec-view image (step S178). The measurement section 130 measures a portion that has been determined to be a target portion in step S154. The controller 120 displays a rec-view image (step S180). FIG. 7B illustrates a screen after the photographing instruction has been issued in FIG. 7A. A rec-view image is illustrated on a left-hand side of the screen, and an image of the configuration information is illustrated on a right-hand side. In the rec-view image, the target portion is highlighted (hatched), and a measurement value of the target portion is also displayed.

When the controller 120 determines that the photographing instruction has not been issued (NO in step S174), the processing returns to step S104. The controller 120 determines whether the button “OK” (not illustrated) has been clicked on the screen (step S182). When the controller 120 determines that the button “OK” has not been clicked (NO in step S182), the processing returns to step S104.

When the controller 120 determines that the button “OK” has been clicked (YES in step S182), the controller 120 records a photographing result in association with the configuration information 154 in the storage 150 (step S184). The controller 120 also records the photographed image and a measurement result of the shape of the portion in the storage 150.

The controller 120 displays a guide screen with an electronic marker indicating a photographing situation added to the configuration information (step S186). An electronic marker Q is an example of situation information. In FIG. 7A, assume that a pillar PA at a right-hand end is clicked at the time of photographing. On the guide screen of FIG. 7B, the electronic marker Q “finished”, which indicates “photographed”, is added to the pillar PA at the right-hand end. The guide screen generator 142 adds the electronic marker Q on the basis of the determination of the photographed portion determination section 128. The processing of the controller 120 returns to step S104.

Proceed now to the description of FIG. 4C. When the controller 120 determines that “construction photographing” has not been selected (NO in step S104), the controller 120 determines whether “image reproduction” has been selected (step S200).

When the controller 120 determines that “image reproduction” has been selected (YES in step S200), the controller 120 reproduces the image (step S202). The controller 120 determines whether an instruction to change the reproduced image has been issued (step S204). When the controller 120 determines that the instruction to change the reproduced image has been issued (YES in step S204), the controller 120 changes the reproduced image according to the instruction (step S206). When the controller 120 determines that the instruction to change the reproduced image has not been issued (NO in step S204), the processing returns to step S104.

When the controller 120 determines that “image reproduction” has not been selected (NO in step S200), the controller 120 determines whether “design drawing acquisition” has been selected (step S210). When the controller 120 determines that “design drawing acquisition” has been selected (YES in step S210), the controller 120 issues a request for the design drawing information 422 to the external apparatus 40 via the communicator 170, and receives the design drawing information 422 transmitted from the external apparatus 40 (step S212). The process of step S212 is a process similar to the process of step S136 described above. The controller 120 records the received design drawing information 422 as the second configuration information 154b in the storage 150.

Next, highlighting processing using the second configuration information 154b based on the received design drawing information 422 is briefly described.

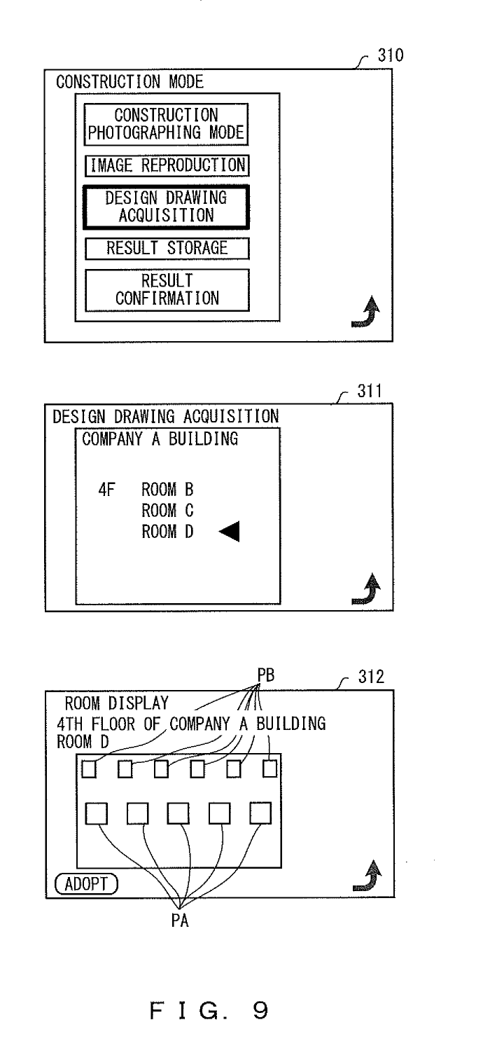

FIG. 9 illustrates an example in which the second configuration information 154b based on a design drawing is displayed. The setting screen 310 of FIG. 9 is an example of a setting screen at the time of the acquisition of a design drawing. When “design drawing acquisition” has been selected on the setting screen 310 of the construction mode, a design drawing is acquired from the external apparatus 40. The setting screen 311 of FIG. 9 is a screen on which a portion to be displayed is concretely specified in the acquired design drawing. A photographer moves a cursor, and specifies a configuration information location to be displayed.

The setting screen 312 of FIG. 9 is a screen of a design drawing indicating the location specified on the setting screen 311 (Room D on the fourth floor of Company A building). The setting screen 312 of FIG. 9 indicates a state in which five pillars PA and six pillars PB are arranged in the room. The pillars PA are targets to be photographed. When the button “adopt” on the setting screen 312 is clicked, the displayed design drawing indicating Room D on the fourth floor of a Company A building is adopted as the second configuration information 154b.

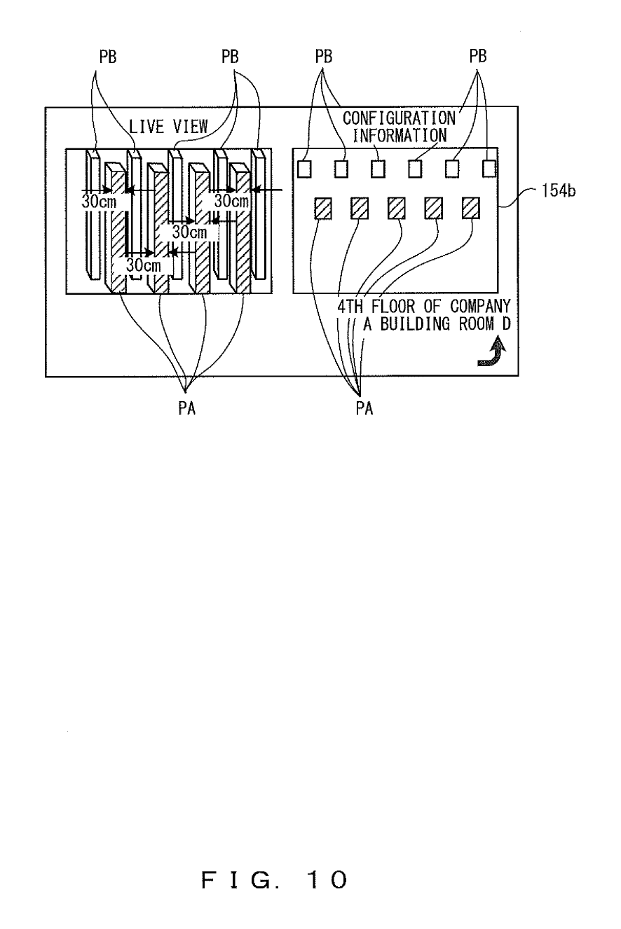

FIG. 10 illustrates a guide screen based on the second configuration information 154b that has been adopted on the setting screen 312 of FIG. 9. A live-view image is illustrated on a left-hand side of the screen, and the second configuration information 154b is illustrated on a right-hand side of the screen. The live-view image has a layout in which a pillar at a right-hand end is not included. In the live-view image, the pillars PA, which have been determined to be target portions, are highlighted. Measurement values of the measured pillars PA are also displayed.

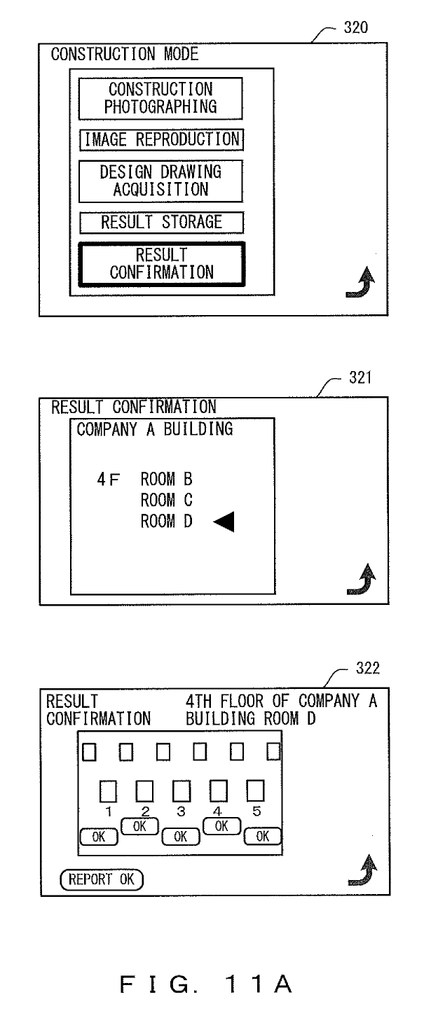

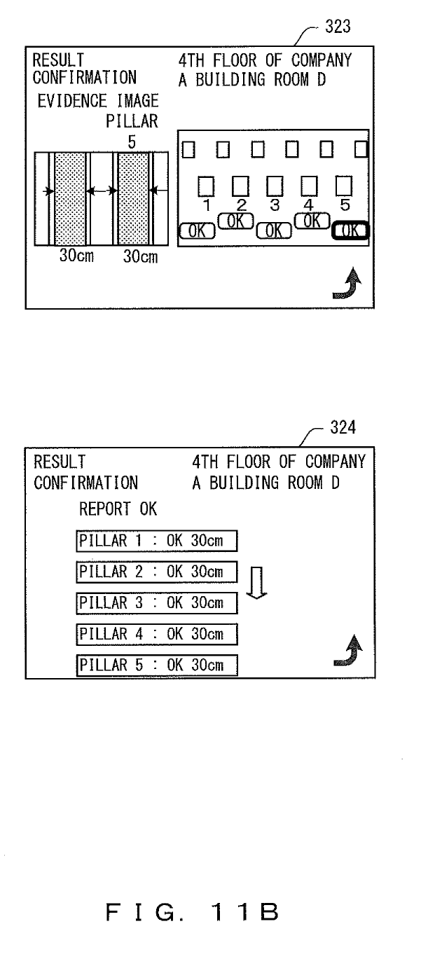

Return now to the description of step S210 in FIG. 4C. When the controller 120 determines that “design drawing acquisition” has not been selected (NO in step S210), the controller 120 determines whether “result confirmation” has been selected (step S220). The process of “result confirmation” is described with reference to respective setting screens in FIG. 11A and FIG. 11B. FIG. 11A illustrates a setting screen 320 on which “result confirmation” is selected as the construction mode.

When the controller 120 determines that “result confirmation” has been selected (YES in step S220), the controller 120 displays place specification (step S222). The setting screen 321 of FIG. 11A is an example of a screen on which a place for which a result will be confirmed is specified. Assume that “result confirmation” is selected on the setting screen 320 of FIG. 11A, and that Room D on the fourth floor of the Company A building, which has been described above with reference to FIG. 9, is specified as a place for which a result will be confirmed. The setting screen 322 of FIG. 11A is a screen indicating a photographing result of Room D on the fourth floor of the Company A building, which has been specified.

On the setting screen 322, a number and situation information (the mark “OK”) indicating a photographing situation are added to each of five pillars PA on the design drawing. The mark “OK” indicates that a pillar that is a target portion has been photographed and that a measurement value of the pillar (the width of the pillar) satisfies the standards.

The controller 120 determines that an instruction to generate a report of the photographing result has been issued (step S224). When “report OK” is clicked on the setting screen 322 of FIG. 11A, the controller 120 determines that the generation instruction has been issued.

When the controller 120 determines that the report generation instruction has not been issued (NO in step S224), the controller 120 does not generate a report. As an example, when pillar no. 5 is clicked on a guide screen of the setting screen 322, the controller 120 displays a details confirmation screen, as illustrated in the setting screen 323 of FIG. 11B (step S228). A photographed image (an evidence image) of pillar no. 5 and the measurement value that have been stored in the storage 150 are displayed on the details confirmation screen.

When the controller 120 determines that the report generation instruction has been issued (YES in step S224), the controller 120 displays the generated report on a text basis (step S226). The setting screen 324 of FIG. 11B is a screen indicating an example of the text-based content of the generated report.

When the controller 120 determines that “result confirmation” has not been selected (NO in step S220), the controller 120 determines whether “result storage” has been selected (step S230). When the controller 120 determines that “result storage” has been selected (YES in step S230), the controller 120 transmits the photographing result to the external apparatus 40 (step S232). The photographing result includes the photographed image, the report generated in step S226, and the like. The external apparatus 40 stores the transmitted photographing result in the storage 420.

When the controller 120 determines that “result storage” has not been selected (NO in step S230), the processing returns to step S104. Also after step S206, step S212, step S226, step S228, step S232, or the like, the processing returns to step S104.

The target portion determination of step S112 or step S154 is described with reference to FIG. 12A to FIG. 15B. Representative schemes of the processing of target portion determination are described as target portion determination 1 to target portion determination 4. A portion to be photographed has variations such as a pillar, a beam, a reinforcing bar, or a groundsill, and the construction environment is not limited to a normal building or house, and has variations such as underground construction or tunnel construction. Accordingly, in order to accurately determine a target portion according to the environment or conditions described above, the target portion determination section 136 appropriately selects or combines one or more of the following four determination schemes so as to perform determination processing.

FIG. 12A is a subroutine of target portion determination 1. FIG. 12B and FIG. 12C are schematic diagrams explaining the processing of target portion determination 1. Target portion determination 1 is processing for determining a surface layer portion (a target portion) on the basis of the appearance of a photographed portion and a photographing distance to a member that corresponds to the portion.

The target portion determination section 136 determines and classifies image characteristics such as an outline and a photographing distance for respective portions (P1 to Pn) (step S300). n is the number of portions that exist on a screen. On the screens of FIG. 12B and FIG. 12C, n=7 is established. The image characteristics such as an outline of each of the portions are determined by the image characteristics determination section 136a. The photographing distance of each of the portions is calculated by the photographing distance calculator 132.

Assume that k is an integer and that k=1 to n. The target portion determination section 136 initializes k such that K=1 (step S302). The target portion determination section 136 classifies the image characteristics such as an outline of the respective portions and the photographing distances of the respective portions, and examines an overlapping relationship among the respective portions (step S304). The target portion determination section 136 determines whether another portion is superimposed onto portion Pk (step S306).

When the target portion determination section 136 determines that no other portions are superimposed onto portion Pk (NO in step S306), the target portion determination section 136 determines that Pk is a surface layer portion (target portion) (step S308). The surface layer portion is a portion that does not have another portion that exists closer to the camera section 100 than itself. This is because, as described above, normally, construction progresses from the depth side at the construction site, and a portions that corresponds to a member closest to a camera corresponds to a portion constructed during the latest construction period, namely, a measurement target or a direct photographing target.

A specific example is described with reference to FIG. 12B and FIG. 12C. FIG. 12B illustrates a photographing state when viewed from the top. FIG. 12B illustrates a positional relationship between members no. 1 to no. 7, which respectively correspond to portions P1 to P7 in a photographed image, and the camera section 100. Assume that member no. 1 to member no. 5 are vertical pillars, and that member no. 6 and member no. 7 are horizontal beams. FIG. 12C illustrates a photographed image of the respective portions P1 to P7. Member no. 2 and member no. 4, which are close to the camera section 100, are members to be photographed and measured. Portions P2 and P4, which correspond to member no. 2 and member no. 4, are determined to be a surface layer portion in step S308.

When the target portion determination section 136 determines that another portion is superimposed onto portion Pk (YES in step S306), the target portion determination section 136 determines that portion Pk is not a surface layer portion (step S310). After step S308 or step S310, the target portion determination section 136 determines whether k=n is established (step S312). When the target portion determination section 136 determines that k=n is established (YES in step S312), the target portion determination section 136 terminates this processing. When the target portion determination section 136 determines that k=n is not established (NO in step S312), the target portion determination section 136 increments k such that k=K+1 (step S314), and the processing returns to step S304.

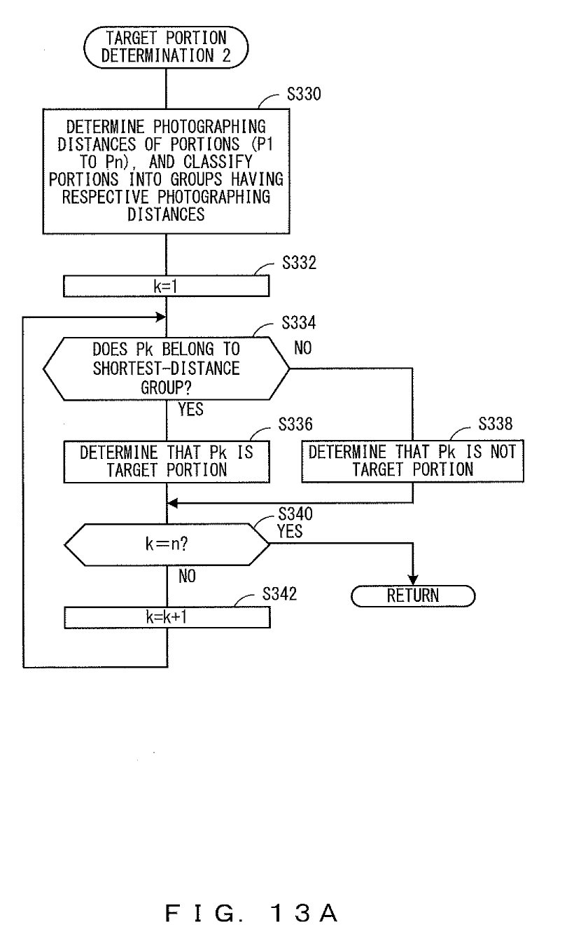

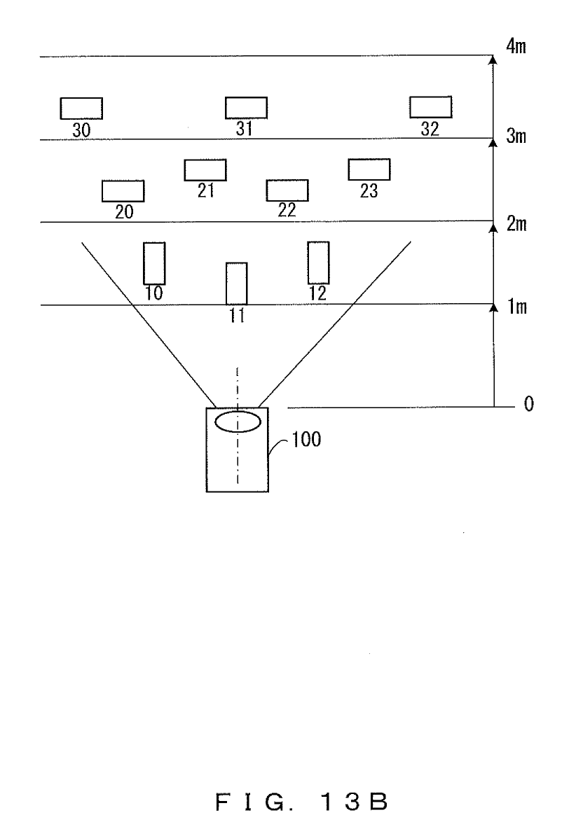

FIG. 13A is a subroutine of target portion determination 2. FIG. 13B is a diagram explaining the processing of target portion determination 2. Target portion determination 2 is processing for determining photographing distances of portions, classifying the portions according to the photographing distances, and determining a surface layer portion according to the classification.

The target portion determination section 136 determines the photographing distances of respective portions (P1 to Pn), and classifies the respective portions according to the photographing distances (step S330). The photographing distances of the respective portions are calculated by the photographing distance calculator 132.

FIG. 13B is a diagram explaining the processing of target portion determination 2. FIG. 13B illustrates a photographing state when viewed from the top, similarly to FIG. 12B. Member nos. 10 to 12 belong to a photographing distance range of 1-2 m. Member nos. 20 to 23 belong to a photographing distance range of 2-3 m. Member nos. 30 to 32 belong to a photographing distance range of 3-4 m. Members that belong to a photographing distance range of 1-2 m, which is close to the camera section 100, are members to be photographed and measured. The setting above of the photographing distance range is an example. A photographer may consider a situation of the construction site, and may set the photographing distance range in advance.

The target portion determination section 136 initializes k such that k=1 (step S332). The target portion determination section 136 determines whether portion Pk belongs to a shortest-distance group (Step S334). The shortest-distance group is a group of 1-2 m in FIG. 13B.

When the target portion determination section 136 determines that portion Pk belongs to the shortest-distance group (YES in step S334), the target portion determination section 136 determines that portion Pk is a surface layer portion (step S336). When the target portion determination section 136 determines that portion Pk does not belong to the shortest-distance group (NO in step S334), the target portion determination section 136 determines that portion Pk is not a surface layer portion (step S338).

The target portion determination section 136 determines whether k=n is established (step S340). When the target portion determination section 136 determines that k=n is established (YES in step S340), the target portion determination section 136 terminates this processing. When the target portion determination section 136 determines that k=n is not established (NO in step S340), the target portion determination section 136 increments k such that k=K+1 (step S342), and the processing returns to step S334.

A portion on the depth side and a portion on the front side may fail to overlap each other on a screen. In this case, a target portion cannot be determined in target portion determination 1. By employing target portion determination 2, even when the portion on the depth side and the portion on the front side are displayed on the screen so as to be horizontally aligned, it is determined that the respective portions have different photographing distances, and therefore the surface layer portion can be reliably determined according to the photographing distances. In addition, in target portion determination 2, determination is performed on a group within a prescribed range, and therefore target portions can be collectively determined.

FIG. 14A is a subroutine of target portion termination 3. FIG. 14B and FIG. 14C are diagrams explaining the processing of target portion determination 3. In target portion determination 3, construction periods of respective members at the current construction site are acquired according to a design drawing (the design drawing information 422) and a member list (the member DB 424), and portions that correspond to members constructed during the latest construction period are specified from among portions in a photographed image. In target portion determination 3, the specified portions are determined to be target portions.

The target portion determination section 136 determines members constructed during the latest construction period (step S360). Specifically, the target portion determination section 136 refers to the design drawing information 422 and the member DB 424 that are acquired from the external apparatus 40, and determines members constructed during the latest construction period at the prescribed construction site. FIG. 14B illustrates an example of a member list based on the member DB 424. According to FIG. 14B, member nos. 301 to 305 are determined to be members constructed during the latest construction period. FIG. 14C illustrates an example of a corresponding design drawing information 422.

The target portion determination section 136 associates a member with a portion according to image characteristics (such as the shape of a member or a construction position of a member) and the determination of a photographing distance (step S362). Specifically, the target portion determination section 136 refers to member information based on the design drawing information 422 and the member DB 424, and associates a member with a portion according to image characteristics and the determination of a photographing distance. The image characteristics and the determination of the photographing distance are similar to those in the process of step S300.

The target portion determination section 136 initializes k such that k=1 (step S364). The target portion determination section 136 determines whether portion Pk belongs to the latest-construction-period group (step S366).

When the target portion determination section 136 determines that portion Pk belongs to the latest-construction-period group (YES in step S366), the target portion determination section 136 determines Pk to be a target portion (step S368). When the target portion determination section 136 determines that Pk does not belong to the latest-construction-period group (NO in step S366), the target portion determination section 136 determines that Pk is not a target portion (step S370).

The target portion determination section 136 determines that k=n is established (step S372). When the target portion determination section 136 determines that k=n is established (YES in step S372), the target portion determination section 136 terminates this processing. When the target portion determination section 136 determines that k=n is not established (NO in step S372), the target portion determination section 136 increments k such that k=k+1 (step S374), and the processing returns to step S366.

By employing the processing of target portion determination 3, a target portion is determined without any direct influence of a difference in the photographing distance. Accordingly, even when another member exists in a position closer to the camera section 100 than the target portion, erroneous determination can be prevented.

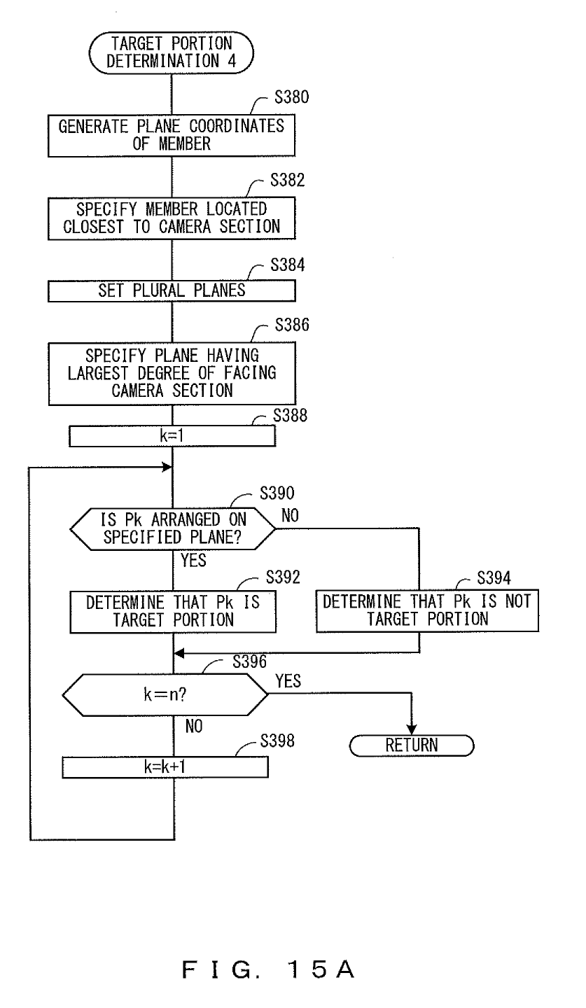

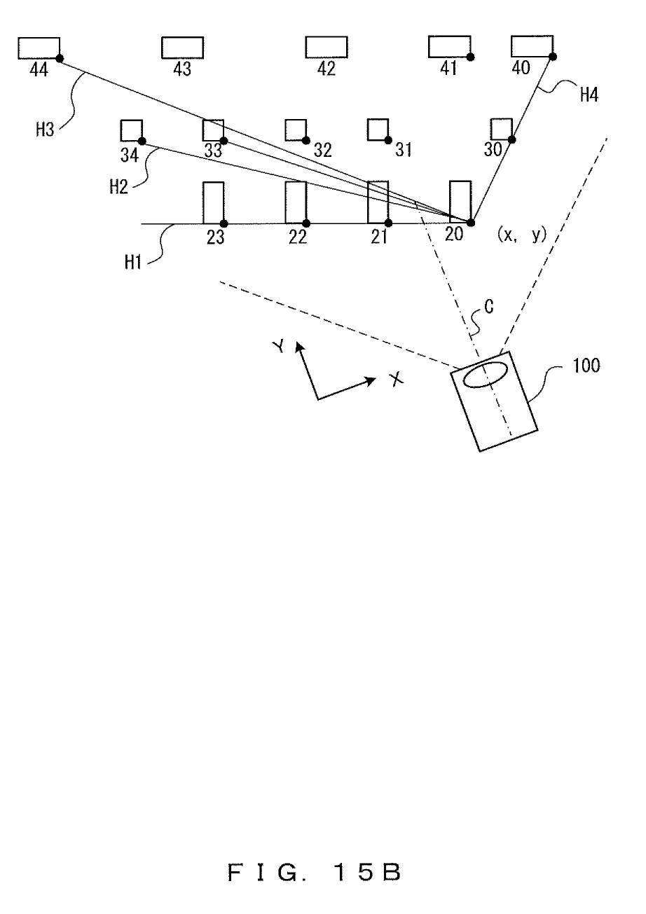

FIG. 15A is a subroutine of target portion determination 4. FIG. 15B is a diagram explaining the processing of target portion determination 4. Target portion determination 4 is processing that enables a target portion to be determined even when photographing is performed in a non-facing state.

The principle of target portion determination 4 is briefly described. First, the target portion determination section 136 generates the plane coordinates of each member, specifies a member that is located at a distance closest to the camera section 100 on the basis of the plane coordinates, and determines the specified member to be one of surface layer members. The target portion determination section 136 sets a plurality of planes that are configured by the member that has been specified as a member located at the shortest distance and another member. The target portion determination section 136 specifies a plane that has the largest degree of facing the camera section 100 from among the set plurality of planes. The target portion determination section 136 determines portions that correspond to members that are located on the specified plane to be target portions.

FIG. 15B illustrates a photographing state when viewed from the top, similarly to FIG. 12B. Assume that member (pillar) nos. 20 to 44 are arranged at the construction site. Member nos. 20 to 23, member nos. 30 to 34, and member nos. 40 to 44 form respective groups constructed during the same period. Member nos. 20 to 23, which are close to the camera section 100, are members (target portions) constructed during the latest construction period. Member nos. 30 to 34 and member nos. 40 to 44 are members constructed during a period before the period of member nos. 20 to 23. The camera section 100 is in an oblique state relative to pillars. This is because photographing can only be performed from an oblique direction according to a state of the construction site in some cases.

The target portion determination section 136 generates the plane coordinates of a member that corresponds to each portion (step S380). The target portion determination section 136 generates the plane coordinates of the member on the basis of image characteristics and a photographing distance. The target portion determination section 136 may further refer to the design drawing information 422 and the member DB 424, and may generates the plane coordinates of the member. The plane coordinates are, for example, coordinates based on XY orthogonal coordinates using the optical axis C of the camera section 100 as a reference (see FIG. 15B).

The target portion determination section 136 uses, for example, a corner of a pillar that is located close to the camera section 100 as a positional reference of a member. The target portion determination section 136 specifies a member that is located closest to the camera section 100 (step S382). In the example of FIG. 15B, member no. 20 is specified.

The target portion determination section 136 sets plural planes including the specified member no. 20 (step S384). In FIG. 15B, as an example, plane H1 is set by using member nos. 20 to 23, plane H2 is set by using member nos. 20 and 34, plane H3 is set by using member nos. 20 and 44, and plane H4 is set by using member nos. 20, 30, and 40. The other planes are omitted.

The target portion determination section 136 specifies a plane that has the largest degree of facing the camera section 100 from among the set planes (step S386). The target portion determination section 136 specifies a plane that has the smallest angle with respect to the X-axis, which is orthogonal to the optical axis C. The plane that has the smallest angle is referred to as a specified plane. In the example of FIG. 15B, plane H1 is specified. The target portion determination section 136 specifies portions that correspond to member nos. 20 to 23, which belong to the specified plane H1, to be target portions. Values of respective plane coordinates of the members that belong to the specified plane H1 have been calculated, and therefore portions that correspond to the members that belong to the specified plane H1 are determined according to the image characteristics and the photographing distance, as described above.

The target portion determination section 136 initializes k such that k=1 (step S388). The target portion determination section 136 determines whether portion Pk is a portion that corresponds to a member arranged on the specified plane (hereinafter referred to as a corresponding portion) (step S390).

When the target portion determination section 136 determines that portion Pk is the corresponding portion (YES in step S390), the target portion determination section 136 determines portion Pk to be a target portion (step S392). When the target portion determination section 136 determines that portion Pk is not the corresponding portion (NO in step S390), the target portion determination section 136 determines that portion Pk is not a target portion (step S394).

The target portion determination section 136 determines whether k=n is established (step S396). When the target portion determination section 136 determines that k=n is established (YES in step S396), the target portion determination section 136 terminates this processing. When the target portion determination section 136 determines that k=n is not established (NO in step S396), the target portion determination section 136 increments k such that k=k+1 (step S398), and the processing returns to step S390.

By employing the processing of target portion determination 4, even when the camera section 100 does not face a member, a target portion can be determined, and therefore constraints on a photographing position and a photographing direction are reduced, and a degree of freedom in photographing increases.

By employing target portion determinations 1 to 4 described above, even when portions having different construction periods exist in a photographed image, a newly constructed portion is accurately determined. By doing this, the shape of a target portion is accurately measured.

A portion to be photographed is highlighted and displayed in a live-view image, a rec-view image, or an image of configuration information. Therefore, omission in photographing, duplicate photographing, and the like can be prevented without referring to a design drawing or the like and confirming a portion to be photographed and the content of photographing that are specified for each construction portion.

An authorization button for authorizing a determination result of a target portion or a change button for issuing an instruction to change the target portion may be provided on a screen. This is because an appropriate portion may fail to be determined according to a situation of the construction site. When an instruction to change the target portion is issued from a photographer, the target portion determination section 136 may switch a scheme to be used from among target portion determinations 1 to 4, or may change priority orders of target portion determinations 1 to 4. The target portion determination section 136 may cause a photographer to select a scheme to be used from among target portion determinations 1 to 4. The target portion determination section 136 may cause a photographer to first specify a single target portion on a screen, and to select a scheme of target portion determination that corresponds to the specified target portion.

In target portion determinations 1 to 4 described above, the determination of a surface layer portion has been described as a specific example. However, a target portion to be photographed or measured is not limited to the surface layer portion. A portion other than the surface layer portion, such as a portion in the second layer, may be used as a portion to be photographed. In this case, a target portion can be specified on the basis of members constructed during the latest construction period, for example, by employing target portion determination 3.

Conventionally, when the shape of a member is measured on the basis of image data at the construction site, a measurement error, such as the measurement of a portion that is not a target to be measured or the measurement of a portion including a target to be measured and the other portions, may be generated. This is because, at the construction site, both a portion that has already been constructed and a portion in the process of construction may exist or different types of portions may be simultaneously constructed. Therefore, a portion other than a target to be photographed (for example, a photographed member) is often included in an image.

When different types of portions are mixed in a photographed image, the different types of portions may be distinguishable from each other at the time of photographing, but which of the different types of portions is a portion to be photographed may fail to be understood after photographing. Accordingly, it is requested that a target to be measured and a target to be photographed can be identified in a photographed image.

By employing the information acquisition apparatus 10 described above, a target portion can be appropriately identified from among portions in a photographed image. Namely, by employing the information acquisition apparatus 10 described above, a measurement error, such as the measurement of a portion that is not a target to be measured or the measurement of a portion including the target to be measured and the other portions, can be prevented.

### Embodiment 2

As Embodiment 2, an information acquisition apparatus 10 is described that sets a photographing range according to a required accuracy of measurement, and displays a portion of configuration information on a guide screen with the photographing range added. The configuration of an information acquisition system 1 and the hardware configuration of the information acquisition apparatus 10 are similar to the contents illustrated in FIG. 2A, FIG. 2B, and FIG. 3, and therefore the description thereof is omitted.

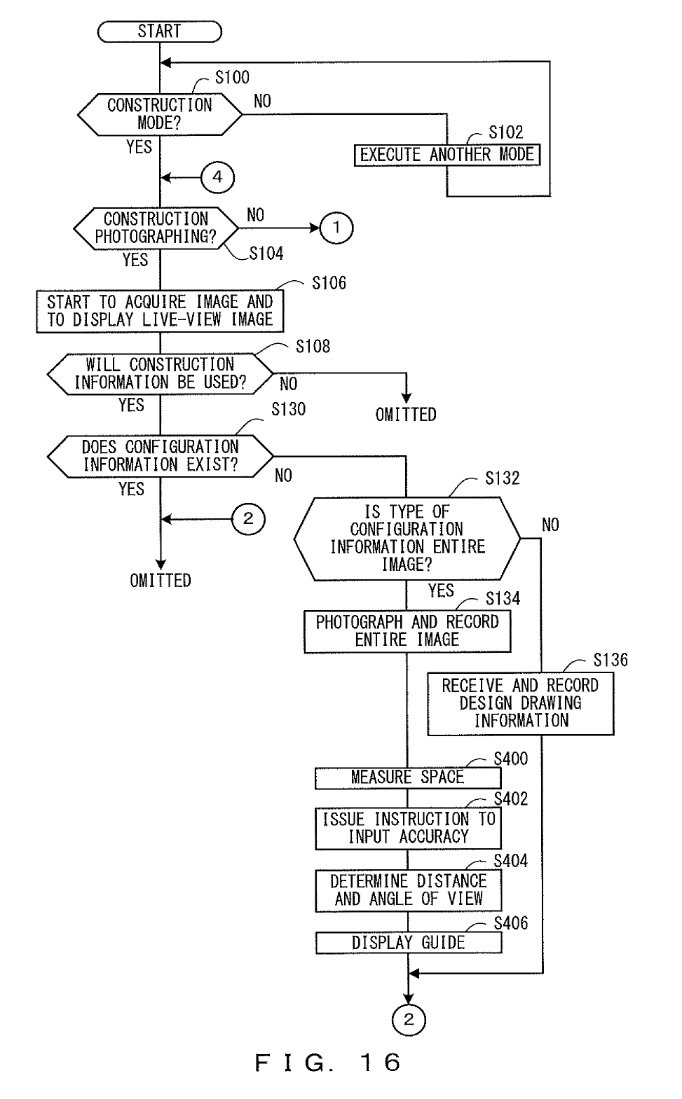

FIG. 16 is a flowchart explaining guide screen display processing according to Embodiment 2. The flowchart of FIG. 16 is a flowchart obtained by adding processing for displaying a photographing range guide indicating a recommended photographing range to the flowchart of FIG. 4A. The recommended photographing range is a photographing range that corresponds to a photographing distance that satisfies a required accuracy of a measurement value of the shape of a member. The photographing range is set accruing to the required accuracy of the measurement value by the photographing range setting section 140 described above. The processes of steps S400 to step S406 are added processes.

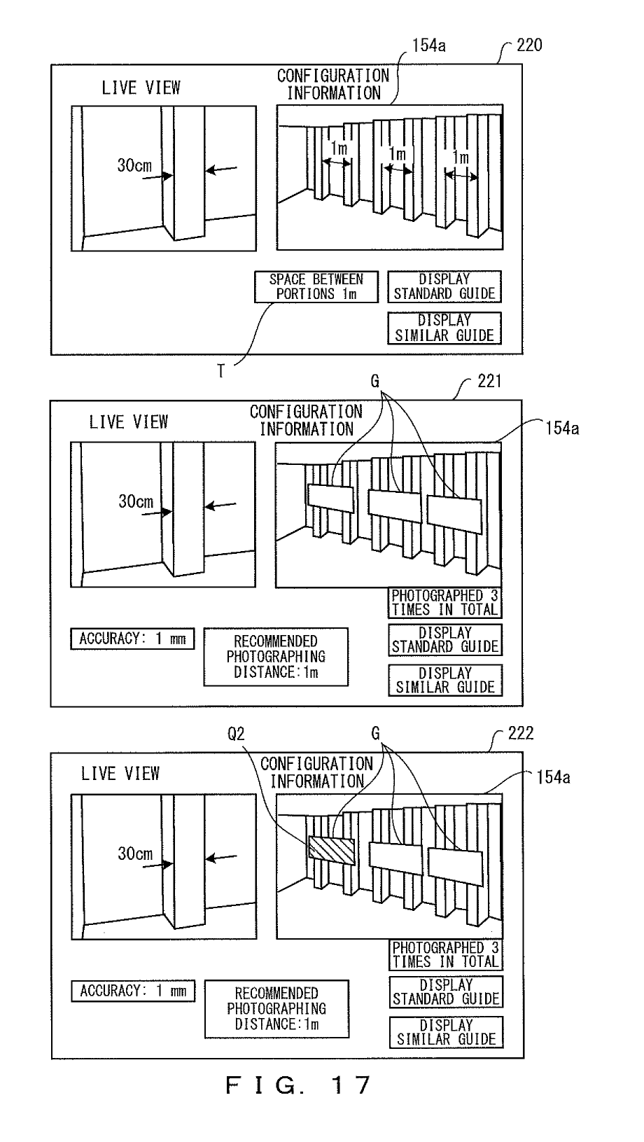

The description below will be given by appropriately referring to FIG. 17. The guide screen of FIG. 17 indicates an example in which the first configuration information 154a is displayed as configuration information. The measurement section 130 measures a space T between pillars on the basis of a live-view image (step S400). The guide screen generator 142 generates a guide screen 220 (FIG. 17) with information (1 m) relating to the space T added. Buttons that cause the reference information generator 134 to display reference information are provided on the guide screen 220. “Display standard guide” is a button for displaying a standard photographing guide. “Display similar guide” is a button for displaying a similar photographing guide.

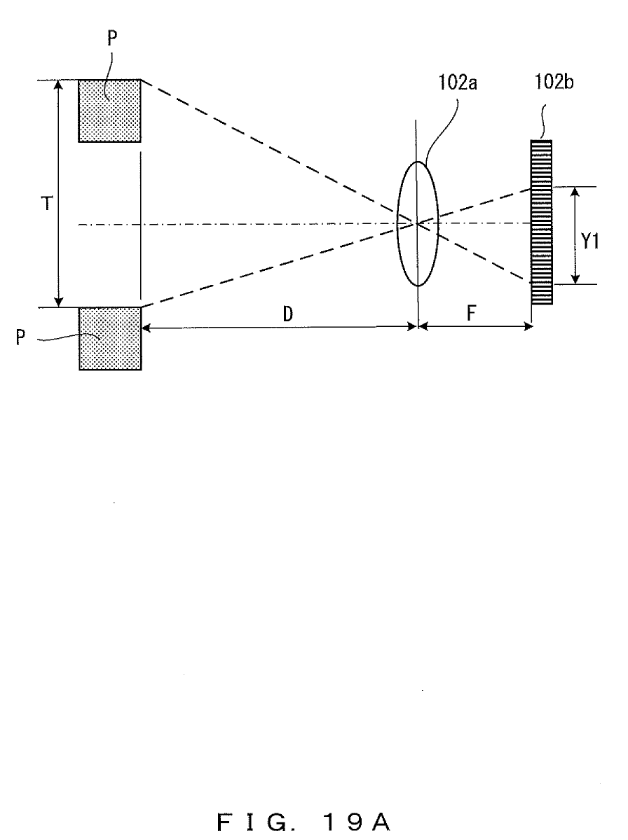

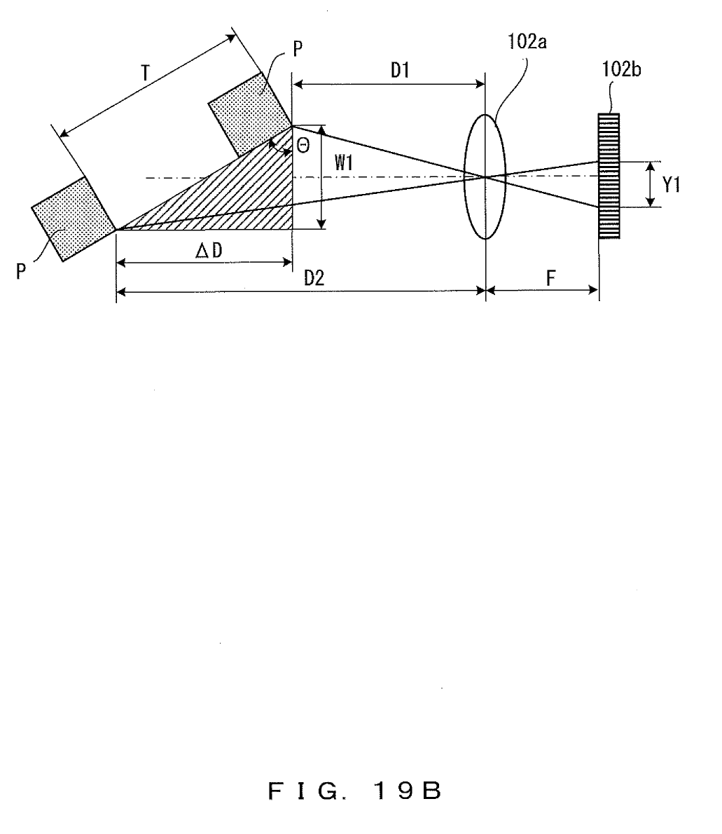

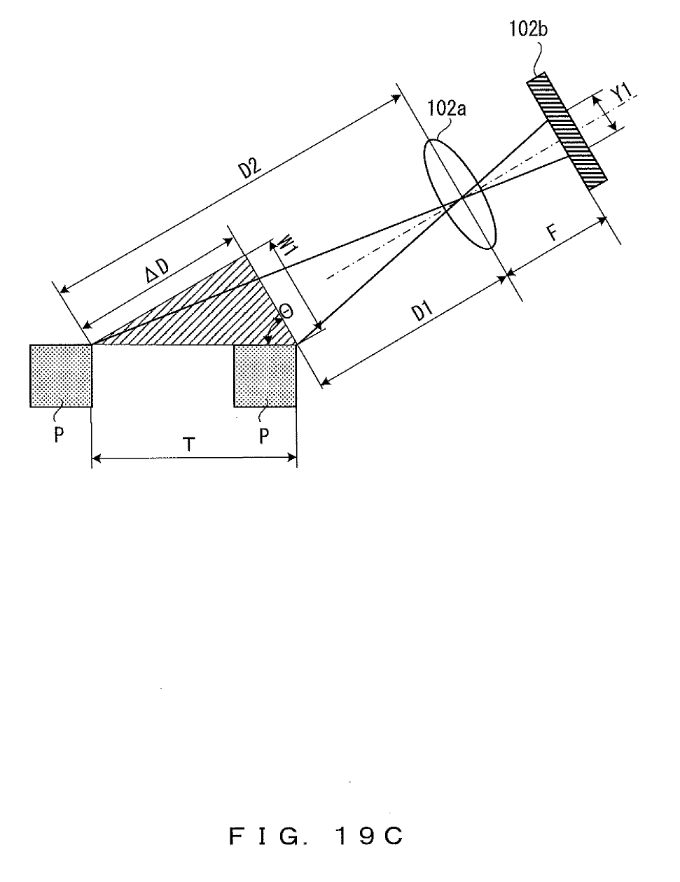

FIG. 19A to FIG. 19C illustrate a principle of measuring a space between pillars on the basis of a photographed image. FIG. 19A illustrates a case in which pillars P are photographed from the front. In FIG. 19A, assume that T is a space between the pillars P, F is a focal length of the lens 102a, Y1 is the width of an image, and D is a photographing distance. The focal length F is included in the camera section characteristics information 156. The photographing distance D is calculated by the photographing distance calculator 132, for example, by detecting a focus. The space T between the pillars P is calculated according to the following formula.

T=D×Y1/F (4)

FIG. 19B illustrates a case in which pillars P are photographed from an oblique direction. In FIG. 19B, assume that T is a space between the pillars P, F is a focal length of the lens 102a, Y1 is the width of an image, and D1 and D2 are photographing distances. The focal length F is included in the camera section characteristics information 156. The photographing distances D1 and D2 are calculated by the photographing distance calculator 132, for example, by detection of a focus. The space T between the pillars P is calculated according to the following formulae.

ΔD=D2−D1 (5)

T=W1/cos θ=W1/cos(arctan(ΔD/W1)) (6)

As described above, even when the camera section 100 is provided in an oblique direction rather than a direction facing the pillars P, the space T between the pillars P can be calculated. By photographing from the oblique direction, the entire image can be easily photographed, and a degree of freedom at the time of photographing increases.

FIG. 19C illustrates a measurement principle in a case in which a groundsill of a floor or a beam or girder of a ceiling is photographed. This is because a portion to be photographed is not limited to a vertical member such as a pillar. As an example, P is a member of a floor. When the member of the floor is photographed, a photographer performs photographing in a state in which the camera section 100 is directed obliquely downward, as illustrated in FIG. 19C. The inclination of the camera section 100 is detected by the posture sensor 110. A space T between the groundsills P is calculated according to the following formulae.

ΔD=D2−D1 (7)

T=W1/cos θ (8)

Return now to the description of FIG. 16. The controller 120 issues, to a photographer, an instruction to input a required accuracy of measurement (step S402). When the required accuracy of measurement has already been input, the controller 120 does not perform this process. Assume, for example, that 1 mm is input as the required accuracy of the pillar P.

The controller 120 determines a photographing distance and an angle of view (step S404). The photographing range setting section 140 calculates the photographing distance that satisfies the required accuracy of measurement. As the required accuracy of measurement increases, a shorter photographing distance is calculated. As described above, the photographing range setting section 140 calculates the photographing distance that satisfies the required accuracy of measurement on the basis of the characteristics of the camera section 100 (an MTF of the lens 102a, a distortion, the resolving power of the image sensor 102b, and the like). The characteristics of the camera section 100 are included in the camera section characteristics information 156.

The photographing range setting section 140 sets a photographing range that satisfies the required accuracy of measurement on the basis of the calculated photographing distance and the characteristics of the camera section 100. The guide screen generator 142 adds a photographing range guide G in a prescribed position of the configuration information 154 in accordance with the set photographing range. The controller 120 displays a guide screen with the photographing range guide G added in the prescribed position of the configuration information 154 (step S406).

The guide screen 221 of FIG. 17 is an example of the guide screen with the photographing range guide G added. On the guide screen 221, “accuracy: 1 mm” indicates an input required accuracy. “Recommended photographing distance: 1 m” indicates a distance calculated according to the required accuracy. The photographing range guide G is displayed in the first configuration information 154a. The photographing range guide G indicates a range (a width in a horizontal direction) that is photographed at a recommended photographing distance of 1 m. In this example, the photographing range guide G proposes a layout in which two pillars are arranged on right-hand and left-hand sides. A screen on a left-hand side is a live-view image. The required accuracy may be manually input, or may be stored in advance. The required accuracy may be a numerical value that changes on the basis of an image, a situation, or a required output form according to the determination of a target object.

The guide screen 221 recommends that a range including the first and second pillars from the left-hand side be a range of the first photographing, a range including the third and fourth pillars P be a range of the second photographing, and a range including the fifth and sixth pillars P be a range of the third photographing. The guide screen 221 also indicates that the number of times of photographing is 3 in total. This is because, by photographing two pillars together, the accuracy is satisfied and the number of times of photographing is reduced, although the required accuracy is satisfied even by sequentially photographing one of six pillars at a distance of 1 m or less.

The guide screen 222 of FIG. 17 is a screen after the first photographing is finished. A photographing range guide G covering the first and second pillars is displayed as a photographed range, for example, with hatching Q2. The hatching Q2 corresponds to the electronic marker Q of FIG. 11. Namely, the hatching Q2 is situation information. By doing this, it becomes clear that the first and second pillars P have already been photographed.

The guide screen may be generated also considering whether photographing can actually be performed, and information relating to the structure of a building, a dangerous place, and the like may be acquired, for example, from an external database, and it may be able to determine whether photographing according to the guide can actually be performed. Stated another way, by using a photographing range indicated by the guide, which position photographing may be performed in can be calculated according to an angle of view and a photographing distance, and therefore, when map information exists, it can be determined whether a photographing position is appropriate. In this case, photographing from an oblique direction rather than from the front, as illustrated in FIG. 19B, may be recommended. Further, whether a photographing position is a safe position at the time of oblique photographing may also be estimated and displayed. Instead of a method for provisionally determining a photographing guide and verifying a photographing position, a method for appropriately acquiring a photographing area and an accuracy and for determining a photographing location from among candidates for safe and appropriate locations (determined according to a map, a plan, design data of a building, or the like) may be employed.

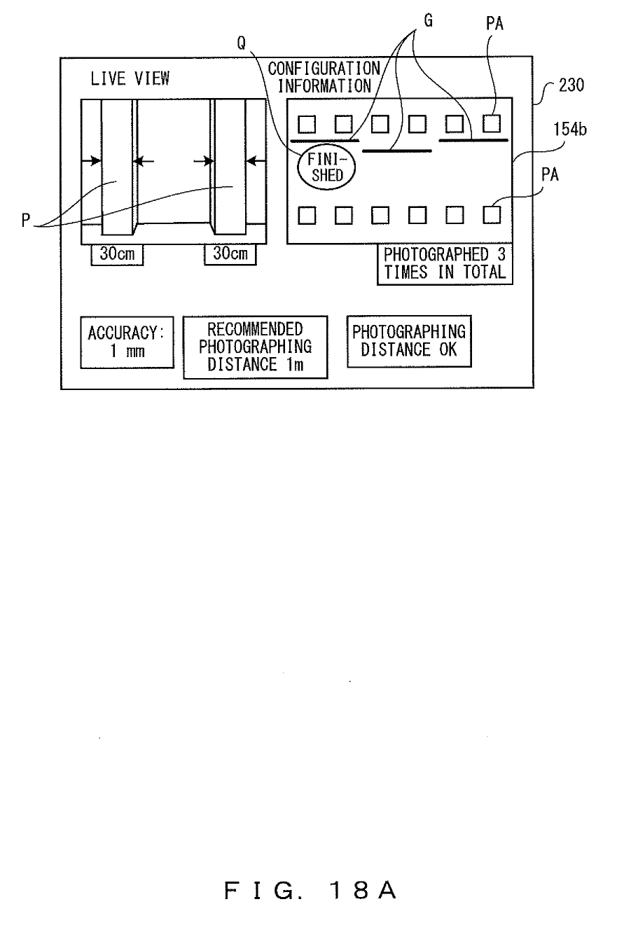

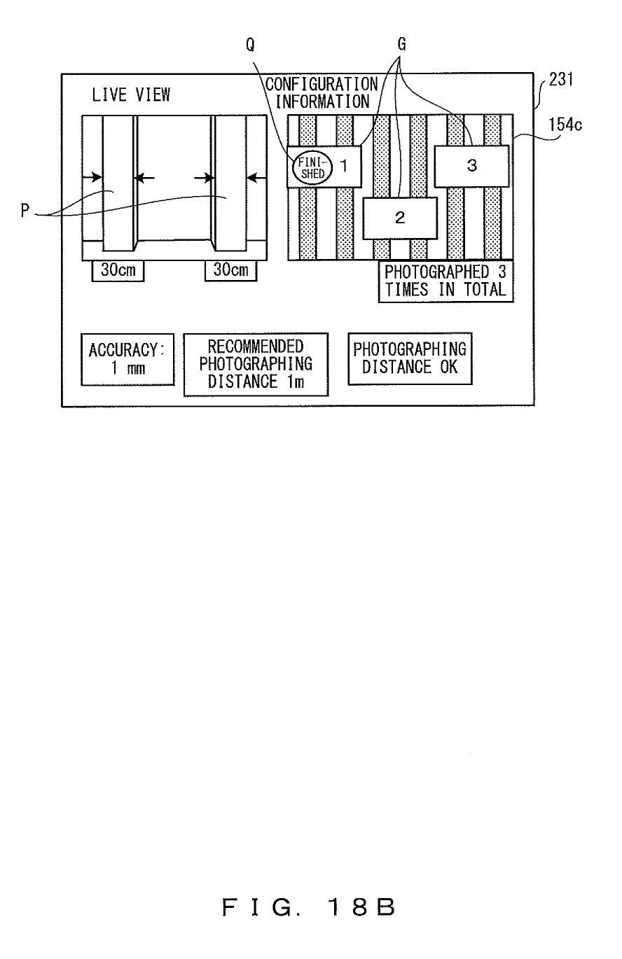

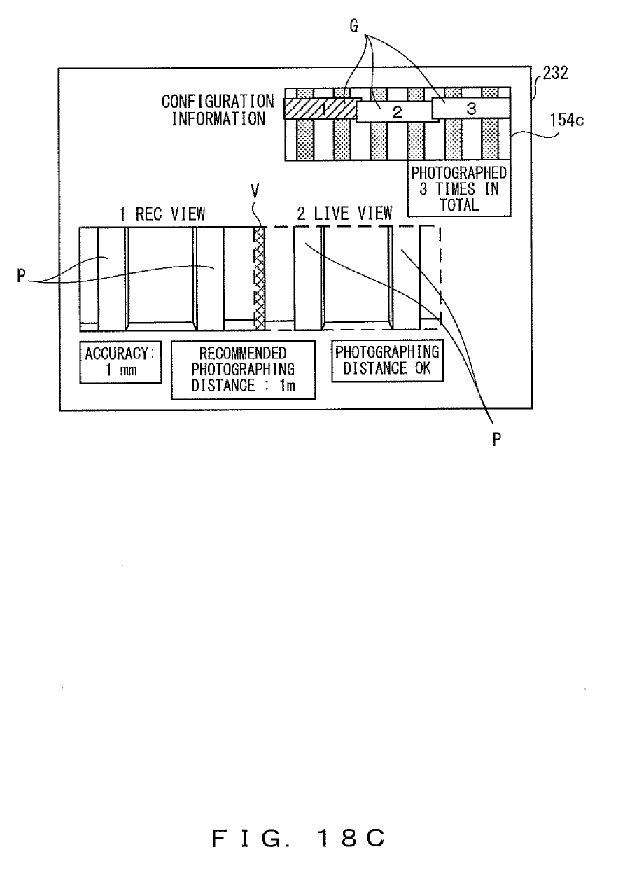

FIG. 18A to FIG. 18C illustrate an example of another display form of the photographing range guide G. FIG. 18A is an example of a guide screen including the second configuration information 154b. The guide screen 230 of FIG. 18A is an example in which the second configuration information 154b is included and a photographing range guide G is displayed with a horizontal line in the second configuration information 154b. An electronic marker Q similar to that of FIG. 7B is displayed in a photographing range guide G according to which photographing has already been performed. In addition, “photographing distance OK” displayed on the guide screen 230 indicates that a current photographing distance is within a photographing distance that satisfies a required accuracy.

FIG. 18B illustrates an example of a guide screen including configuration information 154 of a new form. The configuration information 154 of a new form is a drawing in which six pillars are expanded in a state in which the six pillars are viewed from the front, and this is also referred to as third configuration information 154c.

On the guide screen 231, three photographing range guides G are displayed in the third configuration information 154c so as to cover corresponding pillars. A number (1, 2, or 3) described in the photographing range guide G indicates a photographing order. In a photographing range guide G of number 1, an electronic marker Q indicating that photographing has already been performed is displayed as situation information. FIG. 18C illustrates an example of a guide screen 232 in which plural times of photographing are connected and displayed in a panoramic image style. As configuration information, the same third configuration information 154c as that of FIG. 19B is displayed. The guide screen 232 proposes photographing in which the ends of images overlap each other. Therefore, in the third configuration information 154c on the guide screen 232, a photographing range guide G is displayed in which the ends of photographed images overlap each other. The guide screen 232 of FIG. 18C indicates a state in which the first photographing has been finished and the second photographing is being performed.

A laterally long image displayed on a lower side of the guide screen 232 is an image obtained by combining two images in which pillars P are photographed. A left-hand image is the first photographed image (a rec-view image). A right-hand image is the second photographed image and is a live-view image. The center portion V is a portion in which the first image and the second image overlap each other.

By employing the display described above of the photographing range guide G, omission in photographing, duplicate photographing, and the like can be prevented without referring to a design drawing or the like and confirming a portion to be photographed and the content of photographing that are specified for each construction portion. In addition, a photographing range that satisfies a required accuracy of the measurement of a portion is specified, and therefore an appropriate construction image can be easily photographed.

In addition to the measurement of a portion of a building, as described above, a group of buildings in a specified area, respective trees in a forest, field crops, animals and plants in another area, and the like may be considered as each target portion. In addition, from a macro viewpoint, the present invention can also be applied to the three-dimensional measurement of parts measured in a microscopic image, wiring patterns, semiconductors, and the like considering the respective target objects as respective portions.

Namely, it can be said that any application of the appropriate, accurate, and efficient measurement of respective portions that exist in a specified area and that form a group is the coverage of the present invention. In addition, these respective target objects do not have such a simple shape as that of a building, and a step may be interposed for making a start point and an end point of a portion to be measured easily measurable by performing various types of image processing including simple outline determination such as emphasizing edges. When there are many measurement examples that are frequently measured and that are regarded as a model, determination using a result machine-learnt by artificial intelligence may be performed by using the measurement examples as a model image or a model measurement example. The information acquisition apparatus 10 may be an information processing apparatus that includes the controller 120, the storage 150, and the display 160 excluding the camera section 100.

Note that the present invention is not limited exactly to the above embodiments, and can be embodied in the implementation phases by modifying constitutional elements without departing from the spirit of the present invention. Also, it is possible to form various inventions by an appropriate combination of a plurality of constituent elements disclosed in the above embodiments. For example, all the constituent elements disclosed in the above embodiments may be combined appropriately. Further, constituent elements selected from different embodiments may be combined appropriately. It is as a matter of course that these various modifications and applications are possible without departing from the spirit of the present invention.

### EXPLANATIONS OF LETTERS OR NUMERALS

1 Information acquisition system
10 Information acquisition apparatus
40 External apparatus
100 Camera section
120 Controller
126 Configuration information acquisition section
128 Photographed portion determination section
130 Measurement section
132 Photographing distance calculator
134 Reference information generator
136 Target portion determination section
138 Highlight setting section
140 Photographing range setting section
142 Guide screen generator
144 Display controller
150 Storage
154 Configuration information
154a First configuration information
154b Second configuration information
156 Camera section characteristics information
160 Display
165 Touch panel
170 Communicator
400 Controller
410 Communicator
420 Storage
422 Design drawing information
424 Member DB

What is claimed is:

1. An information acquisition apparatus that acquires a photographed image of a member, the information acquisition apparatus comprising:
a processor that includes:
a target portion determination section that determines a portion that corresponds to a specified member as a target portion in the photographed image; and
a measurement section that measures the target portion in the photographed image so as to acquire a shape of the specified member, wherein
the target portion determination section determines the target portion that corresponds to the specified member from among portions in the photographed image by using, as the specified member, a member that exists on a side close to a direction in which a camera for photographing exists.

2. The image acquisition apparatus according to claim 1, further comprising:
a display controller that highlights and displays the determined target portion in the photographed image.

3. The information acquisition apparatus according to claim 1, further comprising:
a photographing distance calculator that calculates a photographing distance that corresponds to a portion in the photographed image, wherein
the target portion determination section determines the target portion according to the photographing distance of the portion in the photographed image.

4. The information acquisition apparatus according to claim 3, wherein
the target portion determination section classifies the portions in the photographed image into groups according to the photographing distances of the portions in the photographed image, and determines, as the target portion, a portion in the photographed image that belongs to a group having a shortest photographing distance.

5. The information acquisition apparatus according to claim 3, wherein
the target portion determination section determines the target portion according to characteristics relating to the shape of the portion in the photographed image.

6. An information acquisition apparatus that acquires a photographed image of a member, the information acquisition apparatus comprising:
a processor that includes:
a target portion determination section that determines a portion that corresponds to a specified member as a target portion in the photographed image; and
a measurement section that measures the target portion in the photographed image so as to acquire a shape of the specified member, wherein
the target portion determination section determines, as the target portion, a portion that corresponds to a member constructed during a latest construction period according to the photographing distance in a photographed image in which a plurality of members constructed during different construction periods are photographed.

7. The information acquisition apparatus according to claim 6, wherein
the target portion determination section refers to construction period information of members, and determines, as the target portion, the portion that corresponds to the member constructed during the latest construction period in the photographed image in which the plurality of members constructed during the different construction periods are photographed.

8. The information acquisition apparatus according to claim 6, further comprising:
a photographing distance calculator that calculates a photographing distance that corresponds to the portion in the photographed image, wherein
the photographed image is an image of construction photographing in which the member constructed during the latest construction period is photographed such that the member constructed during the latest construction period is located closer to a camera for photographing than a member constructed during another construction period, and
the target portion determination section determines, as the target portion, a portion that corresponds to the member constructed during the latest construction period according to the photographing distance in the photographed image in which the plurality of members constructed during the different construction periods are photographed.

9. A measurement method for measuring a shape of a member according to a photographed image, the measurement method comprising:
determining a portion that corresponds to a specified member as a target portion in the photographed image; and
measuring the target portion in the photographed image so as to acquire the shape of the specified member, wherein
the determining determines the target portion that corresponds to the specified member from among portions in the photographed image by using, as the specified member, a member that exists on a side close to a direction in which a camera for photographing exists.
